(19) United States
(12) Patent Application Publication
(10) Pub. No.: US 2019/0110223 A1
(43) Pub. Date: Apr. 11, 2019

(54) QOS-AWARE ADMISSION CONTROL FOR BODY AREA NETWORKS

(71) Applicant: OLYMPUS CORPORATION, Tokyo (JP)

(72) Inventors: Mohammad Nekoui, San Diego, CA (US); Lichung Chu, San Diego, CA (US)

(21) Appl. No.: 15/781,455

(22) PCT Filed: Dec. 4, 2015
(86) PCT No.: PCT/US15/64099

§ 371 Date: Jun. 4, 2018

(51) Int. Cl. H04W 28/02; H04W 72/12; H04W 48/08; H04W 74/06; H04W 48/16; H04W 76/10

(52) U.S. Cl. CPC H04W 28/0268; H04W 72/1236; H04W 48/08; H04W 84/20; H04W 48/16; H04W 76/10; H04W 74/06

(57) ABSTRACT

Systems and methods of QoS-aware admission control for networks including heterogeneous data traffic types is provided. Embodiments of the present disclosure take into account one or more connection parameters for several data flows within a network in determining whether sufficient resources are available to admit a new flow into the network, accounting for different quality-of-service (QoS) requirements arising from the heterogeneity of the traffic types. Moreover, various embodiments traverse different adjustment options for connection parameters, termination options, or combinations of both to identify the optimal set of flows and connection parameters to achieve bandwidth efficiency while ensuring that lower ranked data flows are not admitted at the expense of higher ranked flows.

### TECHNICAL FIELD

The disclosed technology relates generally to Body Area Networks (BANs), and more particularly, some embodiments relate to heterogeneous data traffic types and admission control accounting for quality of service (QoS) parameters.

### DESCRIPTION OF THE RELATED ART

Wireless BANs are an emerging type of wireless network, and have gained considerable attention due to their health and wellness applications for everyday users. Major targets for BANs are medical body sensors, including those that may be attached to or implanted in the body, as well as devices that provide medical intervention, such as drug delivery devices, or pacemakers (termed “actuators”).

BANs have specific characteristics in terms of topology (e.g., star topology having a hub and one or more body sensors), application requirements, and power consumption that distinguish them from the more widespread wireless Personal Area Networks (PANs). BAN devices are typically small, with limited battery life, making power consumption a major concern.

### BRIEF SUMMARY OF EMBODIMENTS

According to various embodiments of the disclosed technology, a method of admission control for a network, such as a body area network, is provided. In some embodiments, the method comprises a hub device configured to receive a join request message during an unreserved period of a frame period, where the join request message is received from a requesting data flow associated with a connecting network device. The join request message is a message by which the connecting network device seeks to join a network. Upon receipt of the join request message, the hub device determines an available range for one or more connection parameters for the requesting data flow, and sets these one or more connection parameters for the requesting data flow to the a default connection parameter, which may be defined in other embodiments as the maximum of the maximum of the available range.

The hub then determines whether sufficient resources are available within the network to admit the requesting data flow based on the determined available range of connection parameters for the requesting data flow (e.g., based on the default connection parameter). If the hub determines sufficient resources are available, the hub admits the requesting data flow. Additionally, in some embodiments the hub may be further configured to conduct an admission control scheme designed to identify an adjustment option, a termination option, or combination of these options that may result in sufficient resources being available within the network so that the requesting flow may be admitted.

Other features and aspects of the disclosed technology will become apparent from the following detailed description, taken in conjunction with the accompanying drawings, which illustrate, by way of example, the features in accordance with embodiments of the disclosed technology. The summary is not intended to limit the scope of any inventions described herein, which are defined solely by the claims attached hereto.

### BRIEF DESCRIPTION OF THE DRAWINGS

The technology disclosed herein, in accordance with one or more various embodiments, is described in detail with reference to the following figures. The drawings are provided for purposes of illustration only and merely depict typical or example embodiments of the disclosed technology. These drawings are provided to facilitate the reader's understanding of the disclosed technology and shall not be considered limiting of the breadth, scope, or applicability thereof. It should be noted that for clarity and ease of illustration these drawings are not necessarily made to scale.

FIG. 1 illustrates an example wireless body area network (BAN) in accordance with embodiments of the technology of the present disclosure.

FIG. 2 illustrates various states the BAN devices may have during BAN operations in accordance with embodiments of the technology of the present disclosure.

FIG. 3 illustrates an example frame structure for BAN operations in accordance with embodiments of the technology of the present disclosure.

FIG. 4 illustrates an example connection for a BAN device during BAN operations in accordance with embodiments of the technology of the present disclosure.

FIG. 5 illustrates an example in-band signaling in accordance with embodiments of the technology of the present disclosure.

FIG. 6 illustrates an example connection parameter generation process in accordance with embodiments of the technology of the present disclosure.

FIGS. 7A, 7B, and 7C illustrate an example connection process in accordance with embodiments of the technology of the present disclosure.

FIG. 8 illustrates an example update procedure for a short listing of available adjustment options in accordance with embodiments of the present disclosure.

FIG. 9 illustrates an example connection process where the set of requesting flows residing in the network before receiving a new join request is not a null set, in accordance with embodiments of the technology of the present disclosure.

FIG. 10 illustrates an example update procedure where admission of a new flow gives rise to further admissions, in accordance with embodiments of the technology of the present disclosure.

FIG. 11 illustrates an example computing component that may be used in implementing various features of embodiments of the disclosed technology.

The figures are not intended to be exhaustive or to limit the invention to the precise form disclosed. It should be understood that the invention can be practiced with modification and alteration, and that the disclosed technology be limited only by the claims and the equivalents thereof.

### DETAILED DESCRIPTION OF THE EMBODIMENTS

Systems and methods disclosed herein are configured to coordinate the addition of new flows to a communication network, and can be configured to consider QoS requirements in the admission determinations. In some embodiments, systems and methods may be configured to determine a requesting flow's connection parameters from its QoS requirements and physical constraints of the Slave nodes. When a new join request is received, the network hub may determine whether it is able to admit the requesting flow into the network without removing any of the existing flows. To do so the hub may first consider whether the request can be fulfilled with default settings. If it cannot be fulfilled with default settings, the hub may be configured to reschedule existing flows. This may be at the expense of extra, yet minimal, energy consumption. Rescheduling in various embodiments may be accomplished by adjusting the connection parameters (such as reducing the sleep periods between consecutive reservations) of an existing flow. Preferably, the rescheduling is performed so as to not compromise the QoS requirements of the adjusted flows.

In some applications, rescheduling may be carried out through in-band signaling while the connection is in progress. The Hub may also be configured to adjust the connection parameters of the requesting flow in order to admit it into the network. An algorithm for traversing the flow adjustment options may be implemented and may be configured to avoid exhaustive search amongst a myriad of candidates when looking for the flow adjustment option that incurs results in a minimum energy consumption on its Slave nodes. Accordingly, such an algorithm may be computationally efficient.

In circumstances in which the adjustment does not allow admission of a new flow, a bandwidth-efficient yet priority-aware flow termination algorithm may be invoked to free up sufficient bandwidth to allow the new flow to be admitted. In further embodiments, a combination of adjustment and termination of sets of flows may be implemented to identify a solution to the AC problem.

Embodiments of the systems and methods disclosed herein may be implemented with any of a number of different communication networks. One such network is the Wireless Body Area Network, or BAN. BANs have gained considerable attention due to their health and wellness applications for everyday users. BANs have specific characteristics in terms of topology, application requirements, and power consumption that distinguish them from the more widespread wireless Personal Area Networks (PANs). For one, BANs usually have a simple star topology in which the “hub” acts as the central node. A remote data processing/command center can send sensing and actuation commands to a plurality of sensing and actuating “slave” nodes in and around the body, via the hub. The hub then gathers the sensor data and sends it back to the remote data processing center where it is processed and mined to evaluate the health condition of the patient.

Before describing embodiments of the disclosed inventions in greater detail, an example network with which various of these embodiments may be implemented is first described. This example network is that of a BAN. After reading this description, it will become apparent to one of ordinary skill in the art how the systems and methods disclosed herein can be implemented with other networks and in other networking environments.

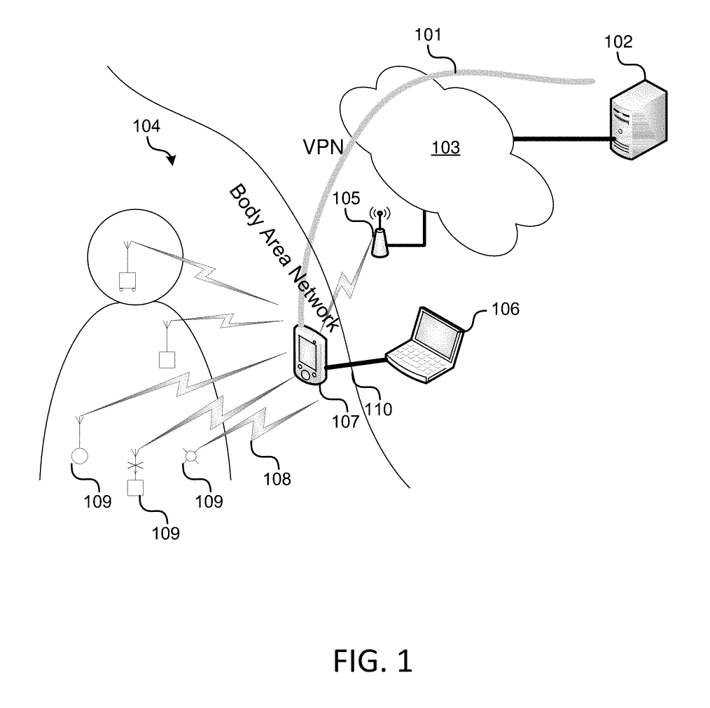

An example BAN environment is illustrated in FIG. 1. The example BAN 104 illustrated in FIG. 1 comprises devices 109 (“slave” devices, such as body sensors and actuators) wirelessly coupled 108 to a hub 107 in a star-topology, single-hop network. The hub 107 forms a connection 101, such as a virtual private network connection (VPN), with a trusted server 102 via a wireless access point 105, such as a wireless router or cellular tower, and a network 103, such as the Internet. For example, the hub 107 may comprise a smartphone or other personal wireless device and may connect to the access point 105 via a networking protocol such as Wi-Fi or a cellular data protocol. In some implementations, the hub 107 may form a second connection 110 to a personal computer or other personal device 106—for example, through direct connections, such as a Bluetooth connection, or through an indirect connection, such as a wireless local area network provided by access point 105.

Because devices 109 in BANs are typically designed to be wearable or implantable, the devices (109) are generally extremely limited by their weight and size, and hence generally have a limited power supply. On the other hand, the hub 107 is typically less mobile, more accessible, and larger in size, and thus typically has a less stringent power consumption requirement (e.g., may have a larger power source).

The trusted server 102 may comprise a remote data processing center—for example, located at a hospital—where data collected by the sensors 109 is processed or stored. The server 102 may issue certain commands to the devices 109 via hub 107. However, in typical implementations, the personal device 106 is used only to access body data and is not allowed to issue commands to the devices 109.

The devices 109 usually have a relatively low data rate (in the order of 100 kbps), low duty cycle (a few minutes of active state in one day), and relatively constant connection duration (a few minutes per connection). However, bursty traffic may be supported. Additionally, the networks 104 are usually relatively stable, with devices 109 rarely joining or leaving the network 104.

BAN applications also impose various QoS-related requirements. Data rates of traffic flows in BANs span a wide spectrum from low-rate intermittent transmissions of medical updates (e.g., body temperature reports once every few minutes) to high rate transmissions of video frames (e.g., video from a capsule endoscope). Besides the data rate, various traffic patterns may each have their own QoS requirements such as reliability, delay, and priority. For example, an alarm message reporting a sudden change in heart rate may have a higher priority than a traffic flow related to regular, routine monitoring of a patient. As another example, real-time traffic from an ECG device may not be as sensitive to a few occasional packet drops as would less frequent traffic, such as glucose level readings, but the former is notable more sensitive to delay than the latter. Accordingly, BAN Media Access Control (MAC) and Admission Control (AC) policies should be able to satisfy a wide range of QoS requirements while minimizing the power consumption of the BAN devices.

Admission control in a BAN and in other communication systems checks to determine whether there are sufficient resources available to allow a device to connect to the network. As noted above, AC policies may be implemented to satisfy a wide range of QoS requirements, while reducing or minimizing the power consumption of network devices. This can be particularly important where the devices are power-sensitive devices such as body sensors (e.g., devices 109 in FIG. 1) or to otherwise account for an asymmetric nature of power limitations between network devices and a network hub, for example. AC can be used to ensure that the QoS requirements for particular traffic types are met during transmission periods. AC ensures that resources are available for all data being transmitted during a particular transmission period. As discussed above, the unique characteristics of BAN communication render many current AC schemes for Wi-Fi and wireless telecommunication networks inadequate or even inapplicable to the BANs. For example, in some network systems, there are no priorities between users and AC is handled on a first-come, first-served basis. In a BAN, the heterogeneous traffic types make it important to ensure that priority schemes are maintained.

Embodiments may be configured to address the different QoS requirements of the heterogeneous traffic types using a determination of connection parameters and admission control scheme. Some non-limiting examples of varied QoS requirements include priority designation, tolerable delay, data rate, and reliability. Conventional AC schemes may not be able to address these. For example, the “first come, first served” scheme used in many conventional networks fails to account for late-arriving flows having higher priority requirements. If “first come, first served” were utilized in a BAN (or other like network having varied QoS requirements), a later-arriving data flow of high importance may be denied admission to the BAN simply because of the relative time at which it was received by the hub. Moreover, the difference in data rate requirements (and possibly reliability) means that the admission scheme of WiFi networks—admitting all traffic, but degrading the throughput when over-populated—also is inapplicable to BANs. If the throughput is degraded, some flows may not be able to meet the data rate QoS requirement, rendering the admission into the BAN unhelpful.

Embodiments of the technology disclosed herein are directed toward methods for allocating resources within a network such as a BAN. More particularly, various embodiments of the technology disclosed herein provide connection parameters for data flows requesting to transmit data within a BAN, while accounting for the varied QoS requirements of the heterogeneous traffic types in the AC process. The connection parameters for a respective flow may be determined, for example, by identifying available ranges for certain parameters (e.g., allocation slot gap, allocation slot size, connection duration) based on the QoS requirements of the flow, as well as the buffer size and power constraints of the associated BAN device. Moreover, various embodiments relate to an AC scheme designed to leverage the identified ranges of connection parameters for the heterogeneous flows. Once a new join request is received from a BAN device, the hub tries to admit the requesting flow into the BAN without removing any of the existing flows. An existing flow is a data flow associated with another BAN device that has already been admitted into the BAN to transmit data. The hub attempts to accommodate the join request by rescheduling the existing flows, at the expense of extra, yet small or minimal, energy consumption. Rescheduling in various embodiments may be accomplished by adjusting the connection parameters (e.g., reducing sleep periods for a BAN device between consecutive reservations) of an existing flow.

In further embodiments, where rescheduling alone is insufficient to enable the new connection, a priority-aware flow termination may be applied. The priority-aware flow termination may be configured to terminate one or more lower-priority flows to allow a higher-priority flow to be admitted. Similarly, this technique can be configured to ensure that higher-ranked flows are not terminated in order to admit a lower-ranked flow. In some applications, a combination of connection-parameter adjustment and flow termination may be utilized to find the optimal solution to the AC scheme, such that the greatest number of connections is maintained in a priority-aware manner.

In discussing various embodiments of the technology disclosed herein, reference is made to the notations in Table 1.

TABLE 1
Relevant Notations
MAC and PHY parameters

| | |
|---|---|
| L | Frame length (s) |
| (1 − β)L | Maximum length of Reserved Period |
| αL | Sum length of Beacon and Schedule Periods |
| l | Minislot length (s) |
| SIFS | Short Inter-Frame Spacing |
| TR | PHY transmission rate |

BAN device physical characteristics

| | |
|---|---|
| ρ_{f}_{ᵢ} | Power consumption coefficient of BAN device serving flow fᵢ |
| E_{f}_{ᵢ}^{max} | Allowable energy consumption of BAN device serving flow fᵢ |
| BF | Buffer size of BAN device serving flow fᵢ (bits) |

Connection Request parameters

| | |
|---|---|
| R_{f}_{ᵢ} | Traffic generation rate of flow fᵢ (bps) |
| D_{f}_{ᵢ} | Tolerable delay of flow fᵢ (s) |
| P_{f}_{ᵢ} | Priority of flow fᵢ |
| A_{f}_{ᵢ} | Reliability requirement of flow fᵢ |
| SD_{f}_{ᵢ} | Sensing duration of flow fᵢ (s) |

Connection Response parameters

| | |
|---|---|
| x_{f}_{ᵢ} | Allocation slot size for flow fᵢ (minislots) |
| G_{f}_{ᵢ} | Allocation slot gap for flow fᵢ (frames) |
| CD_{f}_{ᵢ} | Connection duration for flow fᵢ (frames) |
| DP_{f}_{ᵢ} | Data packet size for flow fᵢ (bits) |

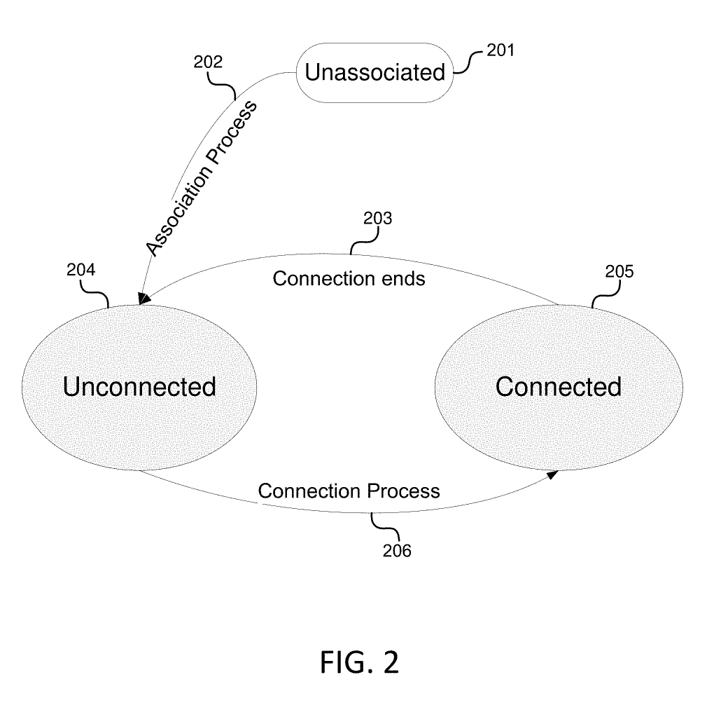

FIG. 2 illustrates various states that BAN devices (e.g., devices 109) may have during network operations in accordance with embodiments of the technology disclosed herein. As illustrated, each BAN device begins in an unassociated state 201. In the unassociated state 201, the BAN device is not part of the network (e.g., has not built a trust relationship with the hub or server). To join the BAN, the BAN device completes an association process 202 where the trust relationship between the hub and the BAN device is established. The association process 202 comprises transmitting an association request message from the device to the hub. Additionally, any signaling from the server required to initialize the BAN device's connection to the network can take place during the association process 202. Additionally, devices that are able to access an emergency request period (emergency-capable devices) can register with the hub during the association process 202.

Once the BAN device associates with the network 202, the BAN device is in an unconnected state 204. In the unconnected state 204, the BAN device retains an association with the network, including the trust relationship with the hub. For example, once the device is in the unconnected state 204, session keys can be generated and exchanged without signaling from the server. A device in the unconnected states 204 is typically in a sleep state. However, in some cases, the device may use an unreserved communication period (discussed below) to communicate with the hub while in the unconnected state 204. The hub assumes that a device in the unconnected state 204 is asleep, and will not schedule downlink packets for an unconnected device. Instead, if there is a downlink packet pending, the hub posts the device's ID in a wakeup list (described below).

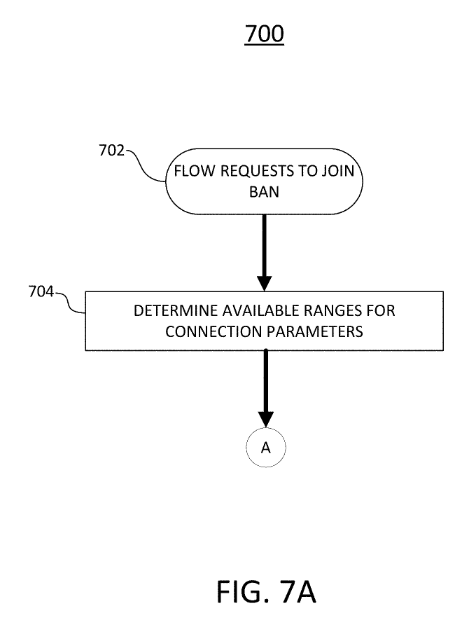

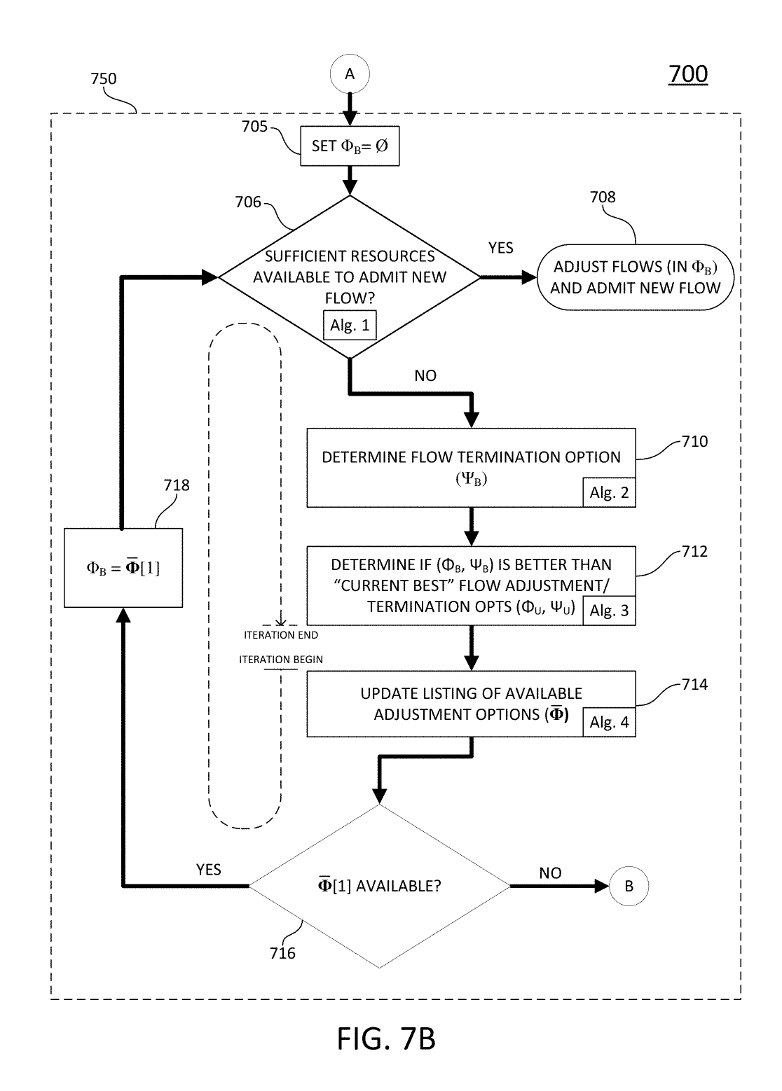

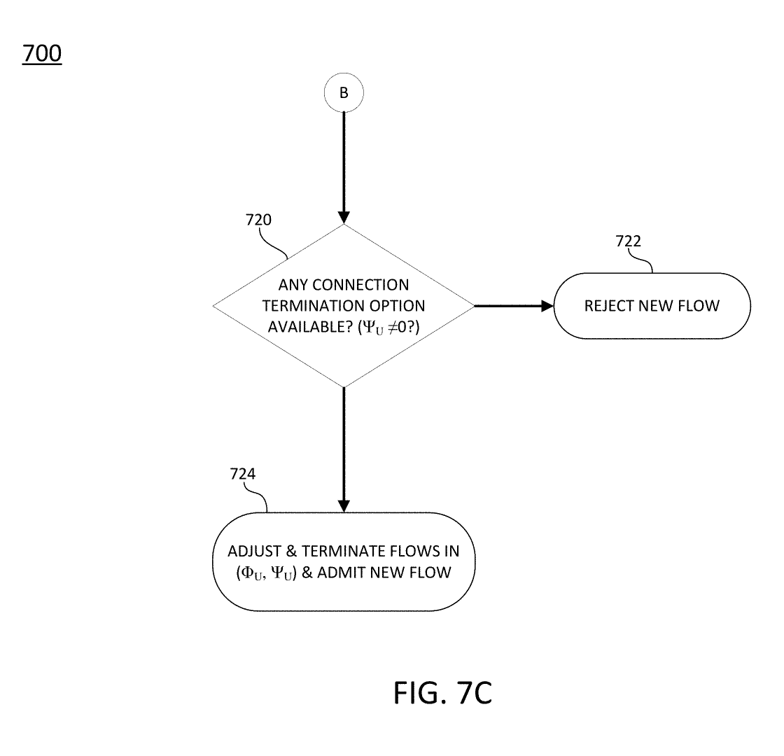

When the device has data to transmit to the hub, it performs a connection process 206 to enter a connected state 205. For example, the device may enter the connected state 205 to transmit a sensor report to the server via the hub or to receive packets from the server via the hub. As another example, the device may enter the connected state 205 to transmit an emergency message. The connected state 205 is the state in which a device has its transmission and reception scheduled by the hub. After the scheduled traffic has completed, the connection ends 203 and the device re-enters the unconnected state. In exemplary connection process is discussed in greater detail below with respect to FIGS. 7A, 7B, and 7C.

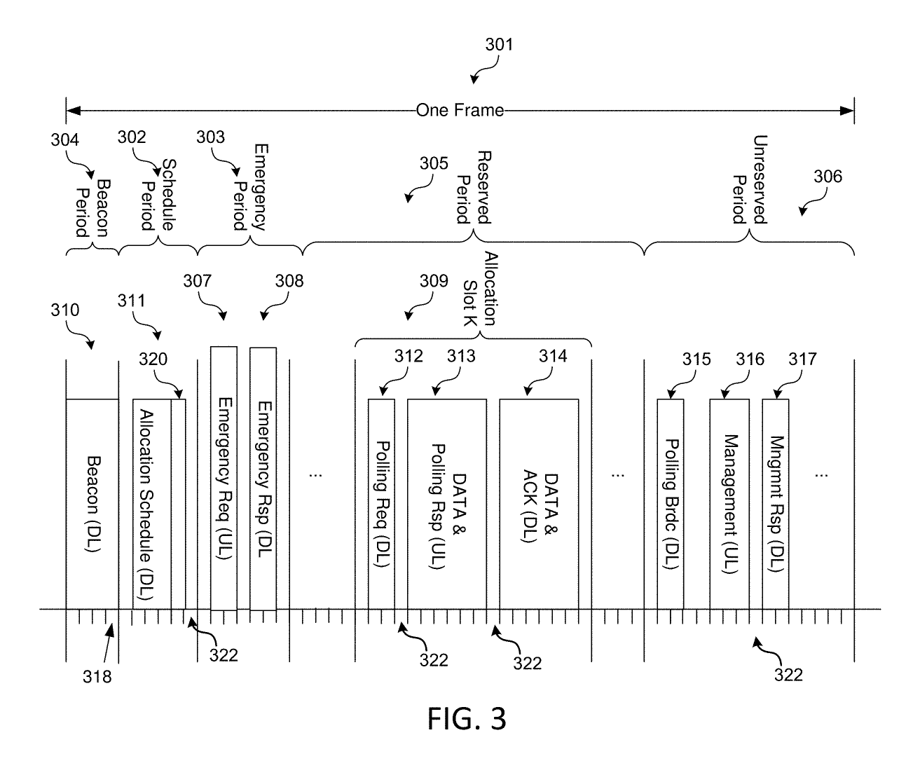

FIG. 3 illustrates an example frame structure for use in a BAN in accordance with embodiments of the technology of the present disclosure. Communications in some implementations utilize time-division multiple access (TDMA) for channel access in the BAN. The BAN time resources are divided into timeslots 318, which are grouped into frames 301. Transmissions in the frame 301 are separated by at least one short inter-frame spacing (SIFS) period 322.

The frame 301 begins with a beacon period 304 where the hub broadcasts a beacon 310. The beacon 310 may contain various information, such as, for example, (a) frame synchronization and timing information; (b) BAN information, such as the BAN ID; (c) channel information; and (d) the length of the frame.

In the illustrated example of FIG. 3, scheduling period 302 takes place after the beacon period 304. The hub broadcasts an allocation schedule message 311 during the schedule period 302. The allocation schedule message 311 sets the division between the reserved period 305 and the unreserved period 306. The reserved period 305 is used to communicate with devices in a connected state. The unreserved period 306 is used to communicate with devices in an unconnected state and to communicate with devices in an unassociated state.

The allocation schedule message 311 can include a schedule of which BAN devices reserved allocation slots 309 during the reserved period 305. In some implementations, the allocation schedule message 311 includes the start times of all reserved allocation slots 309. This may be used by the BAN devices to determine the length of their reserved allocation slots 309. In other implementations, the allocation schedule message 311 includes the lengths of the reserved allocation slots 309. In still further implementations, the allocation slots 309 have a fixed length and the allocation schedule message 311 can include an ordered list of BAN devices. In some implementations, the allocation schedule message 311 can further include a start time of the unreserved period 306. For example, the allocation schedule message 311 may include the start time of the unreserved period 306 if it is not calculable from the other information in the allocation schedule message 311.

The allocation schedule message 311 can further include a wake-up list 320. The wake-up list 320 comprises a list of unconnected BAN devices that have waiting downlink packets. For example, and unconnected BAN device may be listed in the wake-up list 320 in consecutive frames 301 until that BAN device builds a connection. In some implementations, the hub may include an expiration timer, and an unconnected BAN may dropped from the wake-up list 320 when the expiration timer expires (e.g., after a predetermined number of frames). The wake-up list 320 allows BAN devices to remain asleep in an unconnected state for long periods. Even if a BAN device may receive unpredictable downlink traffic, there is no need for the device to check for downlink traffic every frame. Rather, the device may be configured to only check the wake-up list 320 periodically because the device will remain on the wake-up list 320 until it builds a connection.

As illustrated in FIG. 3, an emergency period 303 may be included after the scheduling period 302 in various embodiments. The BAN devices that have registered as emergency-capable during the association process 202 (discussed above with respect to FIG. 2) may use the emergency period 303. A greater discussion of communication during the emergency period 303 may be found in related U.S. Patent Publication No. US 2014-0292537 A1, filed Mar. 29, 2013, the disclosure of which is hereby herein incorporated by reference in its entirety.

In various embodiments, a reserved period 305 may occur after the emergency period 303. The reserved period 305 can include on or more allocation slots 309. One or more of the allocation slots 309 in the reserved period 305 can be reserved for a different connected device. Additionally, in some implementations, the hub may reserve one or more allocation slots 309 for non-existent (dummy) devices to allow the hub device to sleep. In some implementations, each allocation slot 309 has a set size. In other implementations, the allocation slots 309 may have different sizes—for example, depending on the connection requirements.

An allocation slot 309 is begun by a polling request message 312 transmitted by the hub. BAN devices may sleep after receiving the allocation schedule message 311 until the start time (or just before the start time) of their scheduled allocation slot 309. Some desynchronization may occur during this sleep period. Accordingly, the BAN devices may be programmed to wake up at least one guard time interval before their scheduled allocation slot 309. The guard time takes into account probable synchronization loss and may be configured to cause the devices to wake a sufficient time before their allocation slot 309 to receive the polling request message 312.

Each polling request 312 can include a device address for the device that is allowed to transmit during the allocation slot 309. In some cases, the device address in the polling request 312 may not match the device scheduled to use the allocation slot 309 as indicated in the allocation schedule message 311. For example, this may occur if a BAN device's allocation slot 309 has been preempted for an emergency allocation slot.

A BAN device transmits to the hub after receiving a polling request message 312 addressed to the device. Accordingly, the device does not need to maintain an accurate network synchronization to become aligned with its allocation slot 309. Thus, in some embodiments, the device can sleep between the allocation schedule message 311 and the allocation slot 309 without maintaining precise network synchronization and without requiring re-synchronization when waking.

The polling request message 312 may further include relative time offset information, for example, the relative time offset information may comprise the current timeslot 318 position of the allocation slot 309. Other BAN devices, such as unconnected devices waking up to use the unreserved period 306 to build a connection, may use the time offset information contained in the polling request messages 312 to align to the network timing. This alignment may be used to reduce the time spent by an unconnected device to search for the beacon 310. For example, if an unconnected device wakes up during the reserved period 305, the unconnected device can listen to the next polling request message 312 to determine the current timeslot of the frame 301. The unconnected device can use this information to determine the time remaining in the current frame 301. The unconnected device may then reenter a sleep state for the remainder of the frame 301 and wake up in time to hear the next beacon 310. Accordingly, the polling request messages 312 can be used to allow unconnected devices to conserve power by allowing these unconnected devices to avoid having to remain awake until the next beacon 310.

The polling request message 312 may further include the duration of the allocation slot 309 (e.g., if the duration is not fixed during network operations), and the BAN device ID of the device able to use the allocation slot 309. If the allocation slot 309 has been preempted by an emergency request 307, the BAN device ID in the polling request message 312 can be configured to differ from the BAN device ID scheduled in the allocation schedule message 311.

After a short intra-frame space (SIFS) 322, the device identified in the polling request message 312 (the polled device) transmits an uplink response 313, comprising an uplink data packet or a polling response message indicating no uplink data. After the response 313, the hub transmits a downlink response 314. The downlink response 314 comprises an acknowledgement (ACK) of the uplink data packet (if transmitted) and a downlink data packet (if the hub has downlink data). In some implementations, each allocation slot 309 may have more than one packet exchange 313, 314. Subsequent uplink packets 313 include an ACK for the previous downlink data packet 314.

In various embodiments, there is no set division between uplink traffic 313 and downlink traffic 314 during an allocation slot 309. This reduces complexity and allows devices to sleep more often. Rather, the allocations schedule message 311 simply schedules the start time (and, in some cases, length) of the allocation slot 309.

The polled device may reenter a sleep state after the last downlink response 314. If the messages 313, 314 do not take up the entire allocation slot 309, the hub may also sleep for the remainder of the allocation slot 309. Additionally, if the polled device does not transmit a response 313, the hub can use the allocation slot 309 to sleep.

The reserved period 305 ends after the last scheduled allocation slot 309. Accordingly, the length of the reserved period 305 can be configured to vary between consecutive frames 301. Additionally, in some embodiments, the reserved period 305 may not occur in a frame 301 if no allocation slot 309 is scheduled for the frame 301.

An unreserved period 306 occurs after the reserved period 305 (or after emergency period 303 in various embodiments, if there is no reserved period 305). In some embodiments, the reserved period 305 has a maximum length to ensure that there is a predetermined minimum length for the unreserved period 306.

BAN devices may use the unreserved period 306 to build a connection with the hub or to transmit bursty uplink data to the hub. Additionally, new network devices may begin or conduct the association process 202 (e.g., as described with reference to FIG. 2) during the unreserved period 306. Devices may also use the unreserved period 306 to rebuild lost connections or change connection parameters. Furthermore, emergency-capable devices may use the unreserved period 306 in the same manner as the emergency period 303.

As discussed above with respect to FIG. 3, data flows scheduled to communicate within a frame of the BAN transmit data during the assigned allocation slot (e.g., an allocation slot 309) during the reserved period. It is during the unreserved period of the frame when a BAN device completes the association and connection processes discussed above with respect to FIG. 2. After association, in order for a BAN device to start a session of data exchange with the hub, the BAN device establishes a connection for the data flow with the hub. It is at this point that the admission control scheme (an example of which is discussed with respect to FIGS. 7A, 7B and 7C) of the BAN is utilized to ensure that a requesting flow is admitted only if sufficient resources are available.

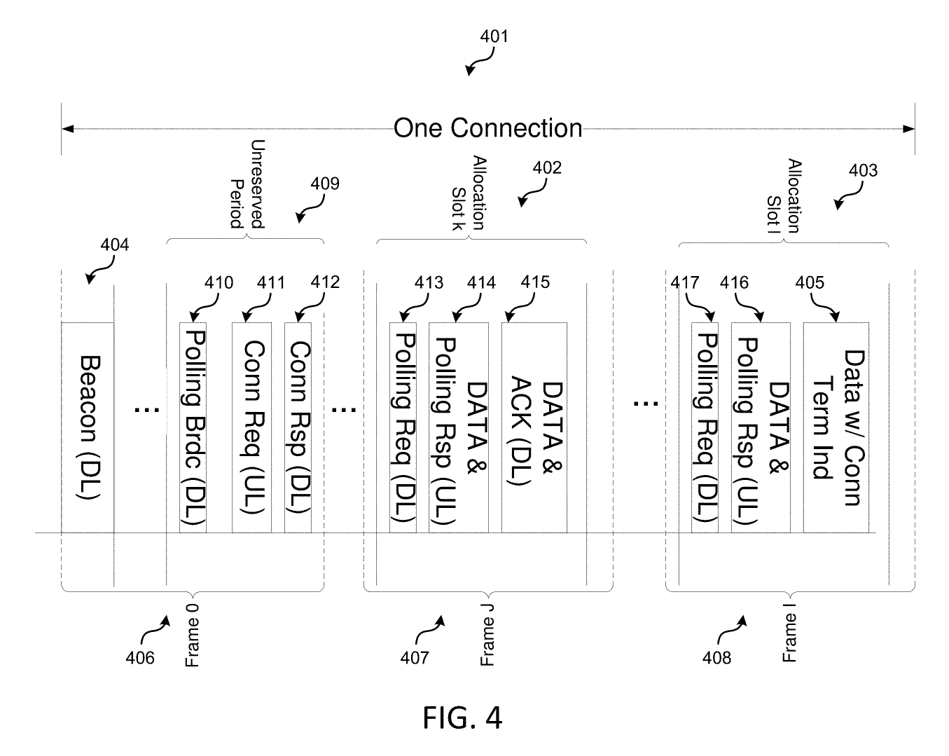

FIG. 4 illustrates an example of a life span of a connection 401 between a hub and a connected device in accordance with embodiments of the technology described herein. The connection in this example comprises a first frame 406 where the connection is built and subsequent frames 407, 408 where communication takes place during corresponding allocation slots 402, 403. In some implementations the number of frames between frames 407, 408 may vary depending on the connection. For example, a connection, such as an emergency connection for a monitoring device, may have an allocation slot 402, 403, scheduled every frame. Another connection may have allocation slots 402, 403 scheduled every other frame, every third frame, or every nth frame.

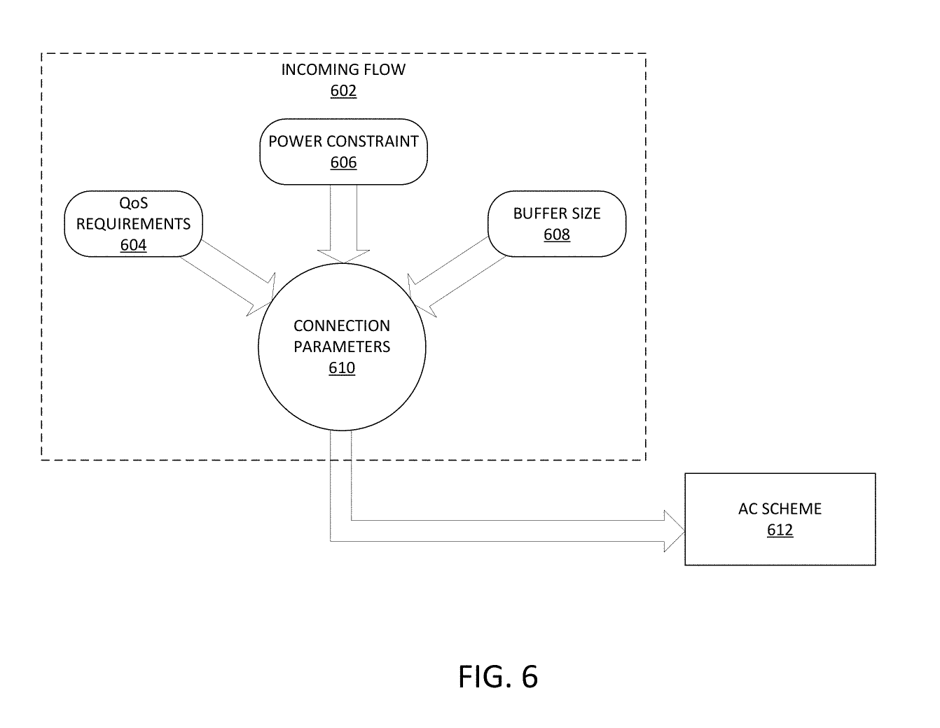

The example connection 401 begins during the unreserved period 409 of the first frame (Frame 0) 406. The device building the connection uses the beacon period 404 (or, for example, a polling message 312, 315 as discussed with respect to FIG. 3) to synchronize to the network timing. During the unreserved period 409 of frame 406, the device listens to the polling broadcast 410 and exchanges a connection request 411 and response 412 with the hub. In some embodiments, the connection request 411 and response 412 are used to set the connection parameters for the connection 401. Connection parameters may include, but are not limited to: the duration of the connection 401; number of frames between allocations slots 402, 403; the data rate used during the connection; priority, traffic direction, allocation slot 402, 403, durations; whether encryption will be used; and other connection parameters. The connection parameters will be discussed in greater detail with respect to FIG. 6.

During the subsequent frames 407, 408 of the connection 401, the device may have allocation slots 402, 403 scheduled for it. As discussed above, the allocation slots 402, 403, can include polling requests 413, 417; uplink data or polling response messages 414, 416; and ACK or downlink messages 415, 405.

Additionally, the last downlink message 405 may include a connection termination indication. In some implementations, the connection 401 length may be extended in certain circumstances. For example, the connection 401 may be extended if unexpected uplink or downlink traffic is generated during the connection, or if one or more allocation slots 402, 403, are preempted by an emergency connection. In these implementations, the device will continue listening to schedules until a downlink message 405 with a connection termination indication is received.

In some embodiments, the BAN may utilize in-band signaling to provide on-the-fly updating of the connection parameters based on the admission process. For example, when additional traffic sources are inserted into an existing reservation (e.g., Downlink traffic (DL) being added to Uplink traffic (UL)), the connection parameters for the already-admitted connections need to be updated. Moreover, a similar update may be provided when a new request to join the BAN is received and the hub determines that the connection parameters of existing flows should to be adjusted to make room for the new flow. Such updates may be accomplished through in-band signaling.

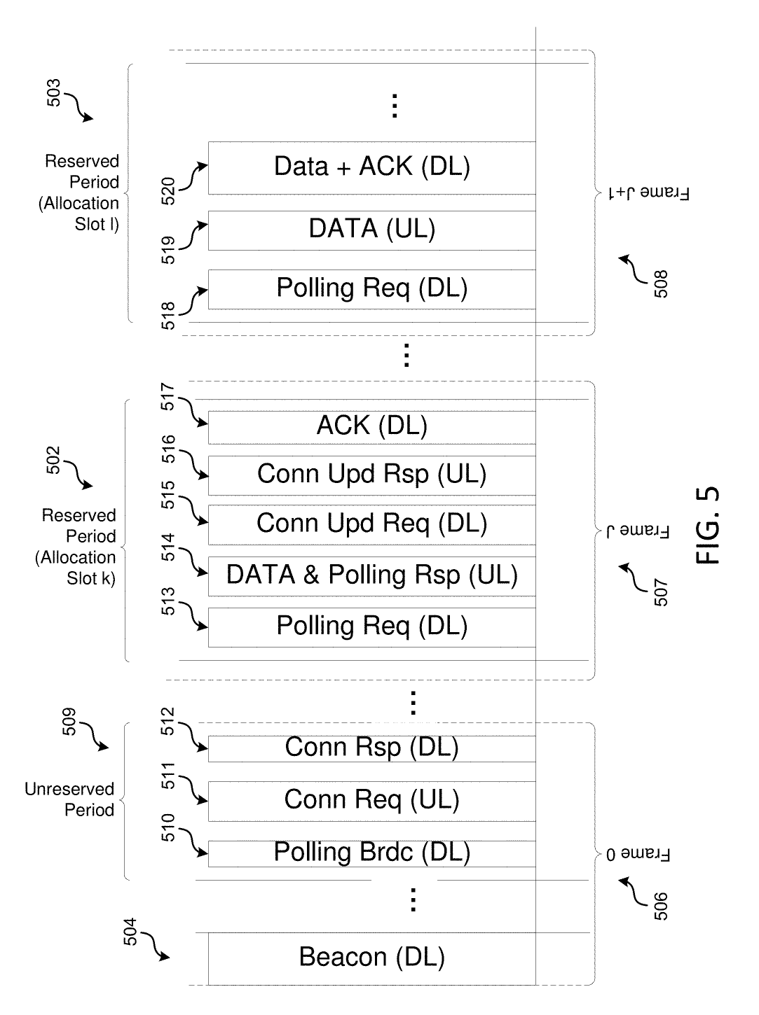

FIG. 5 illustrates an example of in-band signaling in accordance with various embodiments of the technology disclosed herein. One goal of in-band signaling in various embodiments is to aggregate all traffic related to one BAN device into a single allocation slot (e.g. allocation slot 309 of FIG. 3). In various embodiments, the traffic may be data or management/signaling traffic. By aggregating all traffic of a particular BAN device into a single allocation slot, it is possible to achieve longer sleep time and lower power consumption. The example of in-band signaling shown in FIG. 4 is configured with respect to the example frame structure discussed with respect to FIG. 4. The unreserved period 509, beacon message 504, first frame 506, polling broadcast 510, connection request 511 and connection response 512 may be similar to the corresponding elements of the connection 401 of FIG. 4.

To provide the in-band signaling update in accordance with embodiments of the present disclosure, the hub may insert a connection update request 515 in Frame J 507 after receiving a data packet 514. After receiving the connection update request 515, the addressed BAN device may suspend data transmission and respond with a connection update response 516. Starting from frame J+1, the hub uses the new connection parameters to assign reservations for the BAN device. The connection update response 516 may, in various embodiments, approve the download (DL) traffic addition. In various embodiments, the inserted signaling messages may continue the acknowledged sequence number as if the transmission/acknowledgement is still going on, in order to avoid disruption of the ongoing transmission. In various embodiments, the in-band signaling messages may carry their own sequence number, to account for the bi-directional nature of signaling message exchange. When the traffic changes from uni-directional to bi-directional, both sequence number and acknowledged sequence number may be included in the MAC header, as what is in the in-band signaling messages.

As discussed above with respect to FIG. 2, communication between the hub and a BAN device occurs during a connected state 205. Although a BAN device may be associated with the network after the association process 202, data traffic from the BAN device to the hub still must be admitted “into” the BAN in order to transmit data to the hub. The number of data traffic “flows” from BAN devices that may communicate with a hub during the reserved period of the BAN frame, such as the example frame structure discussed above with respect to FIG. 3, is limited by the bandwidth of the BAN. In networks where all traffic types are the same or similar, admission of new flows into the communication frame is simpler as all flows may be treated the same. In such networks, for example, these flows may be handled through the use of a coarse “first come, first served” admission control process.

During the connection process 206 of FIG. 2, a set of connection parameters are determined for the BAN device. Connection parameters represent one or more operational parameters assigned to the flow by the hub to enable the flow to communicate within the BAN. Connection parameters may include, but are not limited to: the duration of the connection; number of frames between allocation slots; the data rate used during the connection; priority of the flow; traffic direction of the flow; allocation slots and durations assigned to the flow; whether encryption will be used; and other connection parameters.

FIG. 6 is a diagram illustrating an example connection parameter generation process in accordance with embodiments of the technology of the present disclosure. Particularly, this figure illustrates an example of how connection parameters 610 for an incoming flow 602 may be created. Continuing with the example of the BAN, the incoming flow 602 originates from a connecting BAN device (i.e., a BAN device that is seeking to transmit data in the BAN), as opposed to a connected BAN device (i.e., a BAN device that has already been admitted to transmit). As discussed above, networks such as BANs may have a plurality of heterogeneous traffic types requesting to transmit data, unlike other networks that may, for example, treat all traffic as having the same priority level. Accordingly, each of the heterogeneous traffic types may have unique QoS requirements, based on the nature of the traffic type, which in various embodiments are accounted for in admitting the flow for transmission.

As illustrated in FIG. 6, an incoming flow 602 represents a new traffic flow from a BAN device that has sent a connection request to the hub, similar to the connection request discussed above with respect to FIG. 4. In various embodiments, the QoS requirements 604 may include, but are not limited to: traffic generation rate; priority; sensing duration; reliability requirements; and/or delay requirements; among others.

The hub receives the connection request from the incoming flow 102 and may also utilize one or more operating characteristics of the BAN device from which the connection request originated in generating the connection parameters 610. The number and type of operating characteristics utilized by the hub may differ based on the implementation. In the illustrated example, the operating characteristics associated with the relevant BAN device include the power constraint 606 and the buffer size 608 of the BAN device. In this way, the hub may account for the operating limitations of the BAN device in addition to the QoS requirements in determining what ranges are possible for the connection parameters 610 of the incoming flow 602.

The QoS vector for flow fᵢ (utilized in determining connection parameters) can be rendered as

Q_{f}_{ᵢ}(R_{f}_{ᵢ}, D_{f}_{ᵢ}, P_{f}_{ᵢ}, A_{f}_{ᵢ}), (1)

where R_{f}_{ᵢ}, D_{f}_{ᵢ}, P_{f}_{ᵢ}, and A_{f}_{ᵢ} represent the flow attributes identified in Table 1.

In order to determine the available range of connection parameters, the value of the frame length L needs to be determined. In various embodiments, L may be the largest length that satisfies the tightest delay requirement among all the flows in the BAN. The value L may be determined, for example, by

$$L = ⌊ \frac{{min}_{{f}_{i}} {D}_{{f}_{i}}}{2 - β} ⌋ , \qquad ( 2 )$$

where the unit of D_{f}_{ᵢ} (and hence L) is in milliseconds, and β represents the portion or fraction of the frame including all periods other than the Reserved Period (discussed above with respect to FIGS. 3 and 4). Because the value of L is a parameter of the BAN, it should not change with either entry or departure of flows in the BAN. Therefore, the minimization in equation (2) may be taken over all foreseeable flows in a BAN, and not just those currently existing therein.

After determining L, the available ranges for connection parameters of a particular flow may be determined. As discussed above with respect to FIG. 2, the BAN device sends a connection request message to the hub during the connection process, identifying the variables within the QoS vector (1) above. In some embodiments, the connection request may also include the power and buffer size constraints of the BAN device. In various embodiments, the power and buffer size constraints may be settled during the association phase of the BAN device from which the connection request originates, and the hub may maintain knowledge of the power and buffer constraints. The hub may utilize the information related to the incoming flow 602 to determine a minimum and maximum value for one or more connection parameters. As discussed in greater detail below with respect to FIGS. 7-10, the maximum value of each available range may be used by the hub as default connection parameters during the connection process for applying admission control.

In various embodiments, the hub utilizes the information relevant to the incoming flow 602 to compute a minimum and maximum allocation slot gap (number of frames between subsequent allocation slots of a flow's connection), which may then be used to derive the allocation slot size (size of an allocation slot in minislots) and connection duration for a particular flow. In calculating the available ranges for the allocation slot gap G_{f}_{ᵢ}, it can be shown that

G_{f}_{ᵢ}^{min}≤G_{f}_{ᵢ}≤G_{f}_{ᵢ}^{max}, (3)

where

G_{f}_{ᵢ}^{min}=max(G_{f}_{ᵢ}¹: allowed by power limitation, G_{f}_{ᵢ}²:allowed by traffic generation rate) (4)

G_{f}_{ᵢ}^{max}=min(G_{f}_{ᵢ}³:allowed by tolerable delay, G_{f}_{ᵢ}⁴:allowed by BAN device buffer size). (5)

In various embodiments, the smaller the gap between subsequent allocation slots, the higher the power usage of the corresponding BAN device. This is due to the extra power consumption associated with the additional overhead linked with the reception of extra beacon, schedule, and polling packets. Therefore, the power constraint of the associated BAN device sets a lower bound (G_{f}_{ᵢ}¹) on the allowable gap,

$${G}_{{f}_{i}}^{1} = ⌈ α \frac{{ρ}_{{f}_{i}} {SD}_{{f}_{i}}}{{E}_{{f}_{i}}^{max} - {E}_{{f}_{i}}^{D}} ⌉ - 1 , \qquad ( 6 )$$

where E_{f}_{ᵢ}^{D} is the total energy consumed by the BAN device of flow fᵢ for transmitting actual data, as the total energy consumption for the additional overhead should be less than E_{f}_{ᵢ}^{max}−E_{f}_{ᵢ}^{D}. Hence, (E_{f}_{ᵢ}^{max}−E_{f}_{ᵢ}^{D}) is the energy consumed listening to beacon and schedule messages where

$${E}_{{f}_{i}}^{D} = {ρ}_{{f}_{i}} ⌈ \frac{{SD}_{{f}_{i}} \times {R}_{{f}_{i}}}{{DP}_{{f}_{i}}} ⌉ \times pPTT , \qquad ( 7 )$$

and the per Packet Transmission Time is calculated as

$$pPPT \approx \frac{{DP}_{{f}_{i}} + ACKsize}{TR} + 2 \times SIFS . \qquad ( 8 )$$

The traffic generation rate, R_{f}_{ᵢ}, places another lower bound on the gap (G_{f}_{ᵢ}²), since resources should not be allocated before enough data is packetized and ready for transmission. The lower bound G_{f}_{ᵢ}² may be shown as

$${G}_{{f}_{i}}^{2} = ⌈ \frac{{DP}_{{f}_{i}}}{{R}_{{f}_{i}} \times L} - β ⌉ , \qquad ( 9 )$$

where the unit of DP_{f}_{ᵢ} is bit.

The maximum allowable gap, G_{f}_{ᵢ}^{max}, should not violate the delay constraint of the flow, D_{f}_{ᵢ}. In addition, it should not be so large as to cause the BAN device's buffer to overflow between subsequent allocation slots. Accordingly,

$$\begin{matrix}{G}_{{f}_{i}}^{3} = ⌊ \frac{{D}_{{f}_{i}}}{L} - 2 + β ⌋ , & ( 10 ) \\ {G}_{{f}_{i}}^{4} = ⌊ \frac{{BF}_{{f}_{i}}}{{R}_{{f}_{i}} \times L} - 2 + β ⌋ , & ( 11 )\end{matrix}$$

where the unit of BF_{f}_{ᵢ} is bit. A negative outcome to equation (11) means that corresponding buffer size is too small to allow for a feasible solution.

Utilizing the allocation slot gap G_{f}_{ᵢ}, the hub derives the allocation slot size and the connection duration. The allocation slot size, x_{f}_{ᵢ}, may be calculated as follows,

$${x}_{{f}_{i}} = ⌈ \frac{PpAS \times pPTT}{l} ⌉ , \qquad ( 12 )$$

where Packets per Allocation Slot (PpAS) is computed as

$$PpAS = ⌈ \frac{{R}_{{f}_{i}} \times L \times ( {G}_{{f}_{i}} + 1 )}{{DP}_{{f}_{i}}} ⌉ . \qquad ( 13 )$$

In equation (8), above, DP_{f}_{ᵢ} (data packet size) and ACKsize represents the total size of those packets including MAC and PHY headers. In all other equations, like equations (9) and (13), DP_{f}_{ᵢ} only represents the application layer size of the data packet. The connection duration, CD_{f}_{ᵢ}, may be calculated as follows,

$${CD}_{{f}_{i}} = ⌈ \frac{{SD}_{{f}_{i}}}{L} ⌉ + {G}_{{f}_{i}}^{max} + 1. \qquad ( 14 )$$

By identifying minimum and maximum values for the connection parameters of each respective incoming flow 602, the hub has flexibility in determining which specific combination of connection parameters to assign a particular flow when scheduling data transmission during frames of the BAN. Moreover, these allowable ranges of connection parameters may be utilized in a sophisticated AC scheme accounting for priorities of each flow, while maintaining bandwidth-efficiency.

The bandwidth-efficient, QoS-aware AC scheme according to various embodiments of the present disclosure may be configured to utilize the identified ranges of available connection parameters of competing flows to determine which flow to admit or maintain in the BAN. The available ranges for connection parameters indicate the possible values for the connection parameters that the hub may assign to each respective flow that would result in a requesting flow being admitted. In various embodiments, the AC scheme is configured to maximize the number of admitted flows (equation (15)) while ensuring that if a new flow is admitted, the connection parameters of that flow are inside the allowable range.

The following Table 2 contains additional notations as used to describe embodiments of the Admission Control formulation.

TABLE 2
Notations Used for Admission Control Formulation

| | |
|---|---|
| fₙ | Newly requesting flow to join the BAN |
| C̅D̅_{f}_{ᵢ} | Remaining duration of fᵢ upon fₙ′s request to join |
| Fₑ | Set of existing flows in BAN before receiving fₙ′s request |
| Fᵣ | Set of requesting flows to reside in the BAN before receiving |
| | fₙ′s request |
| Fₐ | Set of admitted flows into the BAN after receiving fₙ′s |
| | request |
| Cₜ | (⊆ Fₑ) Set of frames with nonzero allocations in frame t |
| X[t] | Sequence representing total allocation slot size in frame t |
| | resulting from Fₑ |
| | $X [ t ] = {\sum }_{{f}_{j} ∈ {C}_{t}} {x}_{{f}_{j}} , 0 \leq t \leq {max}_{{f}_{i} ∈ {F}_{e}} {\overline{CD}}_{{f}_{i}}$ |

Each flow is provided a rank, H_{f}_{ᵢ}, based on the particular QoS requirements of the flow. In various embodiments, categories of QoS requirements may be given different levels of importance in the AC scheme. For example, assume the flows fᵢ and fᵢ are both seeking admission to the BAN. In this example, the priority of a flow is looked at first to determine rank, followed by the tolerable delay for the flow, and then the length of the allocation slot of the flow. In other words, for flows fᵢ and fⱼ, H_{f}_{ᵢ}>H_{f}_{ⱼ}if: P_{f}_{ᵢ}>P_{f}_{ⱼ}; P_{f}_{ᵢ}=P_{f}_{ⱼ}& D_{f}_{ᵢ}<D_{f}_{ⱼ}; or P_{f}_{ᵢ}=P_{f}_{ⱼ} & D_{f}_{ᵢ}=D_{f}_{ⱼ} & x_{f}_{ᵢ}>x_{f}_{ⱼ}. In various embodiments, when two flows have equal rank and neither of the flows exist in the BAN, one flow is chosen at random to be admitted. In some embodiments, a flow is not terminated from a BAN to make admission of a different flow with the same rank possible.

When a new flow fₙ requests to join the BAN, it is faced with two sets of flows: the set of flows already existing in the BAN (Fₑ), and the set of flows that are not currently admitted into the BAN but are candidates to join the BAN (Fᵣ). In various embodiments, two kinds of data flows may be included within Fᵣ: denied flows and terminated flows. Denied flows are flows that sent a connection request to the hub during the current frame, but were denied admission into the BAN. In some embodiments, denied flows may remain in Fᵣ until the end of the current frame, and get removed from Fᵣ for the next frame. In other embodiments, denied flows may be removed from Fᵣ during the current frame.

Terminated flows are flows that were initially admitted into the BAN at some point but were dismissed afterwards. In some embodiments, terminated flows remain in Fᵣ as “valid” candidate flows for re-admission because terminated flows are not aware of the termination until the terminated flow's next allocation slot. In some embodiments, the next allocation slot may be within the current frame or in a future frame. Accordingly, the terminated flows may be able to rejoin the BAN prior to its next allocation slot. Based on the definition of Fₐ serves as Fₑ for the next new request.

For ease of discussion, the AC scheme of the present disclosure will be described first under the assumption that Fᵣ≠Ø, meaning that any denied flow or terminated flow is not reconsidered for admission and needs to resend a connection request message in a later frame to seek readmission.

FIGS. 7A, 7B, 7C illustrate an example connection process 700 implementing an admission control scheme 750 in accordance with embodiments of the technology of the present disclosure. As noted above, embodiments of the admission control scheme can be priority (rank) aware and the QoS requirements of the flows taken into consideration during the admission process. That is QoS requirements of higher rank flows may be entirely fulfilled before lower rank flows are addressed. QoS requirements for different traffic types may include, but not are limited to, priority, delay, and data rate. For example, an alarm flow may have a higher priority than a data flow for regular monitoring. As another example, video flows may require a higher data rate compared to intermittent updates (e.g., measurements that need be taken n times in a day), such that the video flows may be viewed without too much buffering. In various embodiments, the QoS requirements might include reliability. A single BAN device may include one or more heterogeneous traffic types in various embodiments.

Referring now to FIG. 7A, at 702, a requesting flow sends a join request message (i.e., a connection request) to the hub. As discussed above with respect to FIG. 4, a BAN device sends a join request message, which may include the upcoming data flow's QoS requirements in some embodiments. In various embodiments, the QoS requirements may include, but are not limited to: traffic generation rate; priority; sensing duration; reliability requirements; and delay requirements.

The flexibility provided by the identified available ranges for connection parameters of each flow enables the hub to provide a priority-aware AC scheme that seeks to admit more flows (equation (15)) while satisfying the QoS requirements (equation (16)) and the rank requirement (equation (17)).

At 704, the hub determines the allowable ranges for the connection parameters of the requesting flow. In various embodiments, the connection parameters may include, but are not limited to: allocation slot size; allocation size gap; and connection duration. The allowable ranges for the connection parameters may be determined, for example, in a similar manner as discussed above with respect to FIG. 6.

In various embodiments, the solution to the connection parameters may not be unique. This may be seen in equation (3) which shows the allowable range of allocation slot gaps for a respective flow fᵢ. Admission control schemes in accordance with embodiments of the technology disclosed herein exploit the flexibility rendered by equation (3) to accept flows that would not be accepted under traditional admission control schemes. At 704, the allocation slot gap, G_{f}_{ᵢ}, may initially be provisionally set to the default value G_{f}_{ᵢ}=G_{f}_{ᵢ}^{max}, in order to use the minimum amount of power while still fulfilling the QoS requirements of the requesting flow fₙ. By setting the allocation slot gap at the maximum value, adjustments may be made to the allocation slot gap in order to accommodate new flows at the expense of extra power consumption by the BAN devices. This is possible as long as G_{f}_{ᵢ}≥G_{f}_{ᵢ}^{min}. Accordingly, the set of connection parameters determined where G_{f}_{ᵢ}=G_{f}_{ᵢ}^{max} may be referred to as the default connection parameter, which the hub may provisionally assign to the requesting flow fₙ at 704 for assessment.

After 704, the hub decides whether to admit the requesting flow fₙ by applying an admission control scheme.

FIG. 7B illustrates an example admission control scheme 750 in accordance with embodiments of the technology of the present disclosure. The admission control scheme 750 may be designed to

1) Find the set of flows and the corresponding connection parameters that

maximize ∥Fₐ∥ (15)

subject to:

∀fᵢ∈Fₐ:QoS requirements (3), (10), (13)are fulfilled (16)

if ∃fₖ∉Fₐ and Fₐ^{k}⊆Fₐ where ∀fᵢ∈Fₐ^{k}:H_{f}_{ₖ}>H_{f}_{ᵢ} then Fₐ=Fₐ−Fₐ^{k}∪fₖ is not feasible (17)

2) Among solutions found in step 1), find the one with minimum total energy consumption of nodes.

Equation (17) states that it is only possible to admit flows with lower rank than those left out of the BAN, if the removal of the former would still not make it feasible for the latter to join the BAN. In various embodiments, the admission control scheme 750 may include multiple iterations until an adjustment option Φ_{B} is found that frees enough resources to admit the requesting flow fₙ while meeting all QoS requirements of the relevant flows. If the hub checks all possible adjustment options that still meet all the QoS requirements of associated flows and no option makes available sufficient resources to admit the requesting flow fₙ, the hub may apply the best adjustment/termination option pair (Φ_{U}, Ψ_{U}) that is identified during the admission control scheme 750.

The example admission control scheme 750 begins at 705, where the hub may set an initial value for the adjustment option Φ_{B}. The adjustment option Φ_{B} denotes a set of data flows associated with the BAN considered for adjustment, each data flow having one or more connection parameters the hub may assign. For example, a data flow for a first flow f_{first} with an allocation slot gap having a middle value between G_{first}^{min} and G_{first}^{max} (i.e., f [symbol] G_{first}^{mid} [symbol] ). An adjustment option Φ_{B} may include flow f [symbol] G_{first}^{mid} [symbol] , as well as one or more flows associated with other data flows associated with the BAN.

At 705, the hub may set the adjustment option Φ_{B}=Ø. If there are sufficient resources to admit a flow by assigning the default connection parameter to the new flow fₙ (i.e., the maximum value for the allocation slot gap and corresponding values for allocation slot size and duration as discussed with respect to FIG. 6) and with the current connection parameters assigned to the existing flows Fₑ, then the adjustment option Φ_{B} does not need to contain any data flows. This is because the BAN contains sufficient resources to admit the flow without adjusting or terminating any flows.

At 706, the hub determines whether sufficient resources are available to admit the requesting flow fₙ. If sufficient resources are available (based on the default connection parameters for the requesting flow fₙ identified at 704, and the current assigned connection parameters for existing flows Fₑ), the hub admits the requesting flow fₙ into the BAN and assigns the default connection parameters for the requesting flow fₙ. The hub may send a connection response message containing the assigned connection parameters to the requesting flow fₙ at 708.

Before discussing how the hub determines if sufficient resources are present, it is helpful to discuss in more detail X[t] identified in Table 2. X[t] is a discrete time sequence showing the total allocation slot size in frame t, resulting from existing flows, Fₑ. In any iteration during the admission control scheme 750, projected adjustment and/or termination of existing flows (as explained in greater detail below) may be accounted for in computing X[t]. The time index of the frame immediately after the new join request is received by the hub at 702 is set to t=0. For X[t], transition points, γ₀, . . . , y_{N}, are frames indices at which a connection ends or an adjustment takes place (γ₀=0 and γ_{N}=max_{f}_{ᵢ}_{∈F}_{ₑ}C̅D̅_{f}_{ᵢ}). The set F₀⊆Fₑ denotes the set of active flows at t=0 and F_{S}⊆Fₑ, s=1, . . . , N, denotes the set of active flows for γₛ₋₁<t≤γₛ. For each such interval, X[t] is periodic with period \hat{T}ₛ=LCM(T_{f}_{ᵢ}:fᵢ∈Fₛ) where T_{f}_{ᵢ}=G_{f}_{ᵢ}+1 is fᵢ's allocation period.

In order to be admitted into a flow by the hub in accordance with the example admission control scheme 750, there must be sufficient resources available such that the varied QoS requirements of heterogeneous data flows are still satisfied. At 706, sufficient resources may be available where,

$${x}_{{f}_{n}} \leq ( 1 - β ) L - ɛ - X ⌊ {tT}_{{f}_{n}} ⌋ ∀ t ∈ \{ \begin{matrix}0 \text{:} min & ( ⌊ \frac{{CD}_{{f}_{n}}}{{T}_{{f}_{n}}} ⌋ ,\end{matrix} ⌊ \frac{{γ}_{N}}{{T}_{{f}_{n}}} ⌋ ) \} , \qquad ( 18 )$$

where ϵ represents extra room left out for management messages in the reserved period in case an adjustment is needed to be made via in-band signaling. As indicated in equation (17), the hub checks to determine whether equation (18) is satisfied for the smaller of: 1) the duration of the new flow's connection

$$( ⌊ \frac{{CD}_{{f}_{n}}}{{T}_{{f}_{n}}} ⌋ ) ;$$

or

2) the remaining duration of the last flow to end among existing flows

$$( ⌊ \frac{{γ}_{N}}{{T}_{{f}_{n}}} ⌋ ) .$$

For every frame that equation (17) is not satisfied, a “hit” situation occurs. A hit situation means that the channel utilization in the corresponding frame is larger than the maximum capacity of the reserved period (1−β)L.

In some embodiments, the hub may check equation (18) over the entire period t. In various embodiments, the periodic nature of X[t] may be exploited to minimize the computational impact on the hub of checking equation (18) over the entire applicable period t. For every frame, the allocation slot assigned to a particular flow is determined based on the allocation slot gap associated with the flow. In some embodiments, after a certain number of frames, the overall pattern of the allocation slots assigned to each flow may repeat itself.

The periodic nature of X[t] may be exploited by defining

$$\begin{matrix}{a}_{0} = 0 & ( 19 ) \\ {a}_{i} = {min}_{{aT}_{{f}_{n}} > {γ}_{i}} a , i = 1 , … , N - 1 & ( 20 )\end{matrix}$$

which may be utilized in computing

$${a}^{*} = {{min}_{i = 0 , … , N - 1}}_{{γ}_{i + 1} - {a}_{i} {T}_{{f}_{n}} > LCM ( \hat{{T}_{l}} , {T}_{{f}_{n}} )} {a}_{i} \qquad ( 21 )$$

Where no a* exists, no periodicity of X[t] may be exploited by the hub to reduce the computational complexity of (18). Where a* exists, hit situations may be checked for all t∈{0: min

$$( ⌊ \frac{{CD}_{{f}_{n}}}{{T}_{{f}_{n}}} ⌋ , {a}^{*} - 1 ) \} .$$

Then, if CD_{f}_{ₙ}≥a*T_{f}_{ₙ}, the periodic part \tilde{X}[.] of X[.] may be represented as

\tilde{X}[i]=X[a*T_{f}_{ₙ}+i], i=0:\hat{T}ₘ−1 (22)

In view of equation (22), the periodic nature of X[t] may be exploited as the search space for detecting hit situations may be reduced. The search need only check whether

$${x}_{{f}_{n}} \leq ( 1 - β ) L - ɛ - \tilde{X} ⌊ {tT}_{{f}_{n}} mod {\hat{T}}_{m} ⌋ \\ for t ∈ \{ \begin{matrix}0 \text{:} min & ( ⌊ \frac{{CD}_{{f}_{n}} - {a}^{*} {T}_{{f}_{n}}}{{T}_{{f}_{n}}} ⌋ ,\end{matrix} \frac{LCM ( {\hat{T}}_{m} , {T}_{{f}_{n}} )}{{T}_{{f}_{n}}} - 1 ) \} . \qquad ( 23 )$$

Where equation (18) is satisfied for the applicable period, the hub may apply the adjustment option Φ_{B} to the flows associated with the BAN, and the requesting flow fₙ may then be admitted at 708. Where the adjustment option Φ_{B}=Ø, the requesting flow fₙ may be admitted using the default parameters (as application of the null set results in no flow adjustments). In such a situation, bandwidth efficiency is attained as the maximum number of flows are admitted into the BAN (i.e., there were sufficient resources to admit the new flow without requiring a change from the available, energy-efficient connection parameters for the requesting flow fₙ).

If equation (18) is not satisfied (i.e., a hit situation occurs within a frame), the hub may determine a set of candidate flows Ψ at 706. A hit situation indicates that the current connection parameters for the flows associated with the BAN (Fₑ and fₙ) does not allow sufficient resources to be available so that all QoS requirements of all flows may be met if the requesting flow fₙ is admitted. However, termination of one or more existing flows Fₑ may lead to a “no hit” situation (i.e., equation (18) is satisfied). The set of candidate flows Ψ comprises one or more flows identified by the hub out of the set of existing flows Fₑ—that have lower rank than fₙ—that, if terminated, would enable the requesting flow fₙ to be admitted while ensuring all QoS requirements are met for all remaining flows after admission of fₙ.

Accordingly, one or more existing flows Fₑ may need to be terminated to release sufficient resources to admit the requesting flow fₙ. In various embodiments, for each frame with a hit situation, flows that have allocations in that frame, and with a lower rank than the requesting flow fₙ, are added to Ψ by the hub.

Algorithm 1 Check resource availability to admit new flow
Input: X[.], (G_{f}_{ₙ},x_{f}_{ₙ},CD_{f}_{ₙ})
Output: Resource availability, Ψ

| 1: | $for t = 0 : min ( ⌊ \frac{{CD}_{{f}_{n}}}{{T}_{{f}_{n}}} ⌋ , ⌊ \frac{{γ}_{N}}{{T}_{{f}_{n}}} ⌋ ) do$ | | | |
|---|---|---|---|---|
| 2: | \| | if hit occurs at frame t then | | |
| 3: | \| | \| | Resource availability = ”No” | |
| 4: | \| | \| | for each fᵢ ∈ Cₜ do | |
| 5: | \| | \| | \| | if H_{f}_{ᵢ} < H_{f}_{ₙ} then Add fᵢ to Ψ |
| 6: | \| | \| | \| | end if |

| | | | |
|---|---|---|---|
| 7: | \| | \| | end for |

| | | |
|---|---|---|
| 8: | \| | end if |

| | |
|---|---|
| 9: | end for |

If the hub determines at 706 that sufficient resources are not available, at 710 the hub computes a termination option Ψ_{B} such that equation (18) is satisfied. That is, the algorithm nominates for termination the least number of flows that have the lowest possible priorities. As discussed above, conventional termination approaches propose to start removing the existing flow with the lowest priority, and continue removing the next lowest-priority flow until enough resources are made available to admit the new flow.

However, this approach may lead to wasted bandwidth due to unnecessary removal of some flows. At 710, the hub may employ a more bandwidth-efficient, yet still priority-aware termination approach that seeks to remove the minimal subset of lower rank flows from the BAN. For example, assume that Ψ={f₁, f₂, f₃}, where H_{f1}<H_{f2}<H_{f3}. Under conventional termination approaches, the system would determine whether termination of f₁ would release sufficient resources for the new flow to be admitted. If not, the system would then look to see whether terminating both f₁ and f₂, and if terminating those two flows still fails to make available sufficient resources, then the system would see what would happen if all three existing flows were terminated. This potentially results in remaining unused bandwidth due to the termination of too many flows.

In various embodiments, the termination option identification approach employed by the hub at 710 takes into account the difference in ranks associated with the set of existing candidate flows Ψ in determining the termination option Ψ_{B}. The following Table 3 contains additional notations as used to describe computation of the termination option.

TABLE 3
Notations Used in Computing the Termination Option Ψ_{B}

| | |
|---|---|
| Ψ | Set of candidate flows to terminate |
| Π | Partition of Ψ into set of equal ranks |
| | Π = {Πᵢ, i = 1, . . . , z} where H_{fϵΠ}_{ⱼ} < H_{f′ϵΠ}_{ₖ} 1 ≤ j < k ≤ z |
| Πᵢ^{r,m} | r^{th} subset of size m in Πᵢ |
| Sᵢ | 2^{Σ}^{_{k = 1}}^{ⁱ}^{∥Π}^{ₖ}^{∥} − 1, 1 < i ≤ z, (S₀ = 0) |

Continuing with the example above, the hub would sequentially check at 710 the removal of the following sets, in the following order: f₁; f₂; {f₁, f₂}; f₃; {f₁, f₃}; {f₂, f₃}; {f₁, f₂, f₃}. As can be seen, the termination approach employed at 710 considers the minimal subset of flows with the lowest rank in order instead of just seeing if enough resources are available by terminating the next flow in the list. Note that, no flows are actually terminated at 710; the hub is only identifying the best flow termination option Ψ_{B}.

At 710, the flows identified in the set of candidate flows Ψ may be sorted based on increasing order of rank. In various embodiments, the set of candidate flows may be partitioned into a number of subsets Πᵢ wherein each flow included is of equal rank. In the general case the termination option Ψ_{B} is determined based on Algorithm 2.

In the above example, flows f₁ and f₂ are lower rank than f₃. Therefore, the hub looks to see whether removal of the lower ranks, individually first, will result in sufficient resources being available to admit the requesting flow fₙ. By orderly traversing the possible subsets of the existing flows based on rank, the hub can ensure that the minimal number of flows is terminated in order to admit the new flow, resulting in more efficient use of the BAN bandwidth. For example, if sufficient resources are available where {f₁, f₂} are terminated, the flow termination option Ψ_{B} is set as {f₁, f₂}. Where termination of none of the potential flow combinations would result in sufficient resources being made available, the hub may set the flow termination option Ψ_{B}=Ø.

Algorithm 2 Computing the flow termination option
Input: Ψ
Output: Ψ_{B}

| | |
|---|---|
| 1: | Θ₀ ← 0, i ← 1. |
| 2: | for n = 1: z do |
| 3: | \| for m = 1: ∥Πₙ∥ do |
| 4: | \| \| for t = 0: Sₙ₋₁ do |
| 5: | \| \| \| $for r = 1 : ( \begin{matrix}‖ {\prod }_{n} ‖ \\ m\end{matrix} ) do$ |
| 6: | \| \| \| \| Θᵢ₊₊ = {Πₙ^{τ,m}, Θₜ} |
| 7: | \| \| \| \| if termination of Θᵢ leads to “no hit” then |
| 8: | \| \| \| \| \| return Ψ_{B} = Θᵢ. |
| 9: | \| \| \| \| end if |
| 10: | \| \| \| end for |
| 11: | \| \| end for |
| 12: | \| end for |
| 13: | end for |
| 14: | return Ψ_{B} = ∅ |

The flow termination option Ψ_{B} determined at 710 is associated with the adjustment option Φ_{B} of a given iteration of the admission control scheme 750. Accordingly, the hub may maintain a listing of the “current best” adjustment/termination option pair, (Φ_{U}, Ψ_{U}). In this way, where adjustment alone is insufficient to make available sufficient resources, the admission control scheme 750 can still result in admission of the requesting flow fₙ through application of the current best adjustment/termination option pair (Φ_{U}, Ψ_{U}) identified through all iterations of the admission control scheme 750. The use of the current best adjustment/termination option pair (Φ_{U}, Ψ_{U}) will be discussed with respect to FIG. 7C.

At 712, where the hub identified no termination option Ψ_{B} at 710 (i.e., 105 _{B}=Ø), the hub may continue on to 714. Where the hub does identify a valid termination option Ψ_{B} at 710 (i.e., Ψ_{B}≠Ø), the hub may compare the potential adjustment/termination option pair (Φ_{B}, Ψ_{B}) against the current best adjustment/termination option pair (Φ_{U}, Ψ_{U}). Where (Φ_{B}, Ψ_{B}) is determined to be a better option than (Φ_{U}, Ψ_{U}), the hub updates the current best adjustment termination option such that Φ_{U}=Φ_{B} and Ψ_{U}=Ψ_{B}.

Where Ψ_{B}=Ø, the hub conducts no update of the current best adjustment/termination option pair because the adjustment option Φ_{B} was already determined to be insufficient, and there is no termination option that would remedy the hit situation. In various embodiments, the first time Ψ_{B}≠Ø the current best adjustment/termination option pair (Φ_{U}, Ψ_{U}) may be immediately updated by values (Φ_{B}, Ψ_{B}), because the first time Ψ_{B}≠Ø indicates the first adjustment/termination option pair (Φ_{B}, Ψ_{B}) that may result in a “no hit” situation. For each iteration of the admission control scheme 750 following the first time Ψ_{B}≠Ø, the hub updates the current best adjustment/termination option pair (Φ_{U}, Ψ_{U}) only when the adjustment/termination option pair (Φ_{B}, Ψ_{B}) would maintain higher priority flows within the BAN.

In determining whether an update should occur, the hub sorts Ψ_{B} and Ψ_{U} in descending order based on their flows' priorities. The hub performs a pairwise comparison of the priorities of each vector, Ψ_{B} and Ψ_{U}. In various embodiments, the hub performs pairwise comparison until the end of the shorter of the two vectors. If, at any comparison, the flow in Ψ_{U} has a higher priority than its counterpart in Ψ_{B}, the hub updates the current best adjustment/termination option pair (Φ_{U}, Ψ_{U}) by values (Φ_{B}, Ψ_{B}) , since the latter set of flows would be a better option to terminate. If the pairwise comparison shows the flow in Ψ_{U} has a lower priority than its counterpart in Ψ_{B}, the hub can stop the update procedure at 712 and continue with the admission control scheme 750. If all comparisons for the duration of the comparison result in a tie between counterpart entries in the two vectors, the hub may update the current best adjustment/termination option pair (Φ_{U}, Ψ_{U}) if Ψ_{B} is smaller in size than Ψ_{U}. This solution is an effort to keep a maximal number of flows within the BAN. If both vectors contain the same number of entries (i.e., both are of the same size), the hub may compare the flows' tolerable delays and, if still tied, the flows' allocation slot sizes, or the hub may compare the flows' allocation slot sizes and, if still tied, the flows' tolerable delays in various embodiments.

Algorithm 3 Update current best flow
adjustment/termination option

| Input: Φ_{B}, Ψ_{B}, Φ_{U}, Ψ_{U} | | | | |
|---|---|---|---|---|
| Output: Updated Φ_{U}, Ψ_{U} | | | | |
| 1: | if Ψ_{B} ≠ ∅ then | | | |
| 2: | \| if Ψ_{U} = ∅ then Φ_{U} ← Φ_{B} and Ψ_{U} ← Ψ_{B} | | | |
| 3: | \| else | | | |
| 4: | \| | \| Sort Ψ_{B} and Ψ_{U} in descending order of priority | | |
| 5: | \| | \| for i = 1 : min(\|\|Ψ_{B}\|\|,\|\|Ψ_{U}\|\|) do | | |
| 6: | \| | \| | \| if P_{Ψ}_{_{U}}_{[i]} > P_{Ψ}_{_{B}}_{[i]} then | |
| 7: | \| | \| | \| | \| Φ_{U} ← Φ_{B} and Ψ_{U} ← Ψ_{B}, Break |
| 8: | \| | \| | \| else if P_{Ψ}_{_{U}}_{[i]} < P_{Ψ}_{_{B}}_{[i]} then Break | |
| 9: | \| | \| | \| end if | |
| 10: | \| | \| end for | | |
| 11: | \| | \| if (i = min(\|\|Ψ_{B}\|\|,\|\|Ψ_{U}\|\|) & P_{Ψ}_{_{U}}_{[i]} = P_{Ψ}_{_{B}}_{[i]}) then | | |
| 12: | \| | \| | \| if \|\|Ψ_{U}\|\| > \|\|Ψ_{B}\|\| then | |
| 13: | \| | \| | \| | \| Φ_{U} ← Φ_{B} and Ψ_{U} ← Ψ_{B}. |

| | | | |
|---|---|---|---|
| 14: | \| | \| | \| end if |

| | | |
|---|---|---|
| 15: | \| | \| end if |

| | |
|---|---|
| 16: | \| end if |
| 17: | end if |

As discussed above, the admission control scheme 750 may run through multiple iterations to identify whether any adjustment option Φ_{B} makes available sufficient resources to admit the requesting flow fₙ. With reference to FIG. 7B, each iteration of the AC scheme begins at 714. The first time the hub conducts the operations of 706, 710, 712, these operations may be considered as occurring prior to the first iteration of the admission control scheme 750.

Each iteration begins with identifying the next available adjustment option that the hub may assess. At 714, the listing of available adjustment options Φ̅ may be updated by the hub. Flow adjustment may be considered where the hub is unable to admit a requesting flow using the default connection parameters for the requesting flow (i.e., G_{f}_{ₙ}=G_{f}_{ₙ}^{max}) and present connection parameters for existing flows. Through flow adjustment, it may be possible to resolve a hit situation by changing the allocation slot gap within its available range to make additional resources available for the requesting flow fₙ. The hub may select the adjustment option that still fulfills the QoS requirements of all the flows fᵢ∈Fₑ and fₙ with minimal aggregate energy consumption associated with the increased amount of time each BAN device need be awake and transmitting. When adjustment is feasible, it helps to admit the greatest number of flows (thereby making more efficient use of available bandwidth) without increasing the overall energy consumption by an unsustainable amount.

In some embodiments, the listing of available adjustment options Φ̅ may be created at 714 by the hub during the first iteration of the admission control scheme 750. The listing of available adjustment options Φ̅ may be stored in memory for use later during subsequent iterations of the admission control scheme 750. In some embodiments, the listing of available adjustment options Φ̅ may maintain all of the possible adjustment options Φ_{B} for a particular request, sorting the entire list in ascending order (i.e., the option with the least impact on energy consumption is listed first at Φ̅[1]), with each subsequent adjustment option listed at Φ̅[n].

Calculating and maintaining a listing of all possible adjustment options, however, may be too excessive for some BAN applications. Calculating all the possible options may take an excessive amount of time, especially given that one of the first options checked may be sufficient to admit the requesting flow, wasting the processing time and resources necessary to generate the entire list. Moreover, this “brute force” approach would result in higher energy consumption. In various embodiments, a computationally efficient process may be utilized to reduce the computational cost of the brute force method.

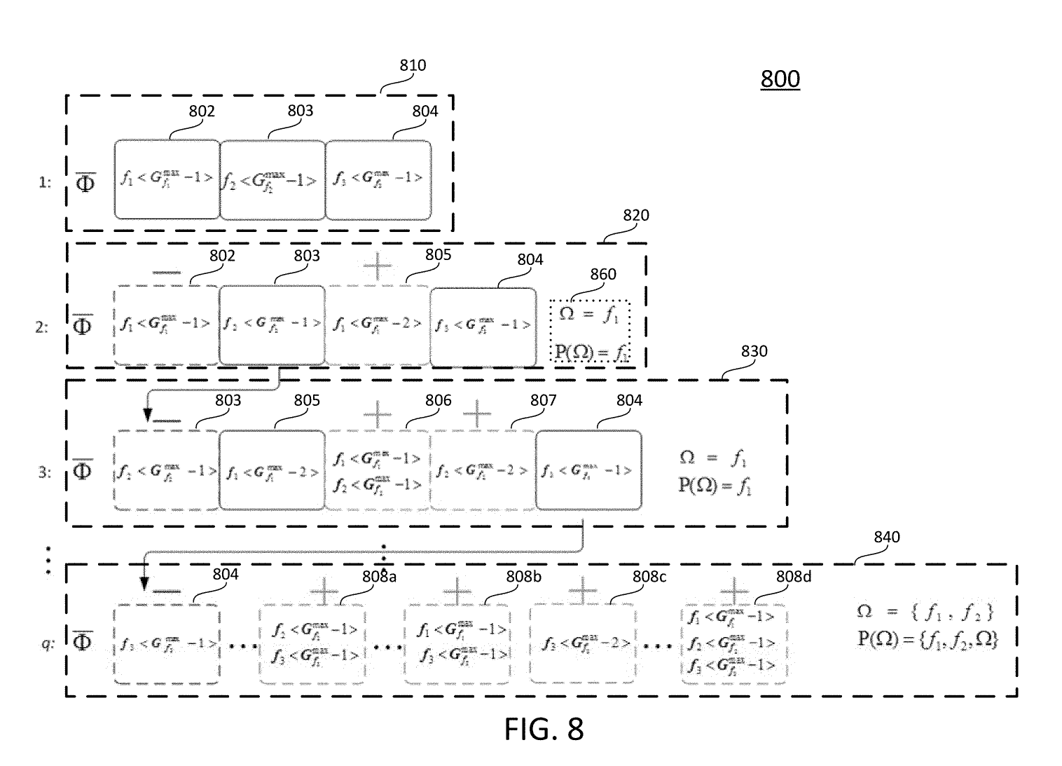

FIG. 8 illustrates an example initialization and updating process 800 implemented by the hub in accordance with various embodiments of the technology of the present disclosure. FIG. 8 shall be referenced to assist in explaining the hub's operation at 714 of FIG. 7B. Although described with reference to the example process of FIG. 8, nothing in this present disclosure should be interpreted as limiting the scope of embodiments of the technology described herein to only such an initialization and updating process. Indeed, after reading this description, one of ordinary skill in the art will understand how other initialization and updating processes may be used.

With reference now to FIG. 8, Fₑ∪Fₙ={f₁,f₂,f₃} denotes all flows available to have connection parameters adjusted associated with the BAN. For the example of FIG. 8, these flows are not the same flows as those used in discussing FIG. 7B. Moreover, the example illustrated in FIG. 8 is provided merely to facilitate describing the technology of the present disclosure, and should not be interpreted to limit the scope of the claims.

During the first iteration 810 of FIG. 8, the listing of available adjustment options \tilde{Φ} is initiated, as the listing was not necessary prior to assessing whether Φ_{B}=Ø is sufficient to admit the requesting flow fₙ. In some embodiments, the listing of available adjustment options Φ̅ may be initialized by

Φ̅:Φ̅[i]=fᵢ [symbol] G_{f}_{ᵢ} [symbol] where G_{f}_{ᵢ}=G_{f}_{ᵢ}^{max}−1, ∀fᵢ∈Fₑ∪fₙ if G_{f}_{ᵢ}^{max}>G_{f}_{ᵢ}^{min}, (24)

where fᵢ [symbol] G_{f}_{ᵢ} [symbol] represents each flow fᵢ with a particular value for the allocation slot gap G_{f}_{ᵢ}.

In the example of FIG. 8, the entries Φ̅[i] correspond to flows f₁,f₂,f₃, with their allocation slot gaps G_{f}_{ᵢ}, reduced by one frame from the maximum value. In various embodiments, the entries Φ̅[i] may comprise flows with different values for the allocation slot gap, including any value as long as G_{f}_{ᵢ}≥G_{f}_{ᵢ}^{min} for each flow fᵢ. When the allocation slot gap of a flow is changed, the additional energy usage is incurred from extra wake-up periods for receiving beacon, schedule, and polling messages. In various embodiments, the entries Φ̅[i] may be sorted in ascending order of energy consumption

E_{Φ̅[i]}(G_{Φ̅[i]})=Σ_{f}_{ₖ}_{∈Φ̅[i]}E_{f}_{ₖ}(G_{f}_{ₖ}) where

$${E}_{{f}_{k}} ( {G}_{{f}_{k}} ) = {ρ}_{{f}_{k}} ( α L + PpAS \times pPTT ) ⌈ \frac{{\overline{CD}}_{{f}_{k}}}{{G}_{{f}_{k}} + 1} ⌉ , \qquad ( 25 )$$

such that the first entry Φ̅[1] represents the adjustment option with the lowest energy consumption compared to the other options. In the identified example, the sorted listing of available adjustment options Φ̅ of the first iteration 810 identifies the adjustment option 802 (f₁ [symbol] G_{f}_{₁}^{max}−1 [symbol] ) as the adjustment option with the lowest energy consumption.

If the adjustment option 802 does not free up sufficient resources to admit the requesting flow fₙ, the hub may check another available adjustment option during each subsequent iteration. As discussed above, the listing of available adjustment options Φ̅ determined in the first iteration 810 included adjustment options corresponding to one frame less than the maximum allocation slot gap of each flow, which may be the simplest adjustment to make. However, in some cases, a more complicated adjustment option may actually be more energy efficient than one of the adjustment options 803 and/or 804. During the update process 714 of the admission control scheme 750 of FIG. 7B, the hub may add additional adjustment options to the listing of available adjustment options Φ̅.

During the first iteration 810, the first entry Φ̅[1], after sorting, was determined to be adjustment option 802. Adjustment option 802 corresponds to an adjustment of flow f₁. In some embodiments, where the first entry Φ̅[1] from the previous iteration contains an adjustment associated with a single flow fᵢ, the hub may determine to add an additional adjustment option

fᵢ [symbol] G_{f}_{ᵢ}−1 [symbol] , (26)

where G_{f}, >Gy_{f}_{ᵢ}^{min}. In the illustrated example of FIG. 8, the first entry Φ̅[1] from the first iteration 810 contained only a single flow, f₁. According to equation (26), the hub would add the adjustment option 805 (indicated by the “plus” sign over the option 805 of FIG. 8). Once all new adjustment options have been added, the hub may then re-sort the listing of adjustment Φ̅ based on the energy consumption of the current entries, as discussed above with respect to the first iteration. The adjustment option 805 has a lower energy consumption than adjustment option 804, but a higher consumption than adjustment option 803. The hub may then delete the previous first entry Φ̅[1] (indicated by the “minus” sign above the option 802), as that option was already considered and failed to result in sufficient resources. Accordingly, the first entry Φ̅[1] of the listing of available adjustment options 40 of the second iteration 820 is adjustment option 803.

In some situations, the first entry Φ̅[1] from the previous iteration may contain more than one potential flow, where all such potential flows have allocation slot gaps G_{f}_{ᵢ}=G_{f}_{ᵢ}^{max}−1. For example, assume that in one previous iteration, the first entry Φ̅[1]={f₁ [symbol] G_{f}_{₁}^{max}−1 [symbol] , f₂ [symbol] G_{f}_{₂}^{max}−1 [symbol] }. In such cases, the hub may add Π_{f}_{_{i∈Φ̅[}}1](G_{f}_{ᵢ}^{max}−G_{f}_{ᵢ}^{min})−1 additional adjustment options.

Each of the new adjustment options includes all fᵢ∈Φ̅[1], and the new entries together cover all possible combinations of fᵢ [symbol] G_{f}_{ᵢ}^{max}−αᵢ [symbol] fᵢ∈Φ̅[1], where 1≤αᵢ≤G_{f}_{ᵢ}^{min}, except for the one already represented in the first entry Φ̅[1]. For the given example, the hub may add the following entries:

$$\begin{matrix}\{ {f}_{1} 〈 {G}_{{f}_{1}}^{max} - 1 〉 , {f}_{2} 〈 {G}_{{f}_{2}}^{max} - 1 〉 \} , … , \{ {f}_{1} 〈 {G}_{{f}_{1}}^{max} - 1 〉 , {f}_{2} 〈 {G}_{{f}_{2}}^{max} - {G}_{{f}_{2}}^{min} 〉 \} \\ \{ {f}_{1} 〈 {G}_{{f}_{1}}^{max} - 2 〉 , {f}_{2} 〈 {G}_{{f}_{2}}^{max} - 1 〉 \} , … , \{ {f}_{1} 〈 {G}_{{f}_{1}}^{max} - 2 〉 , {f}_{2} 〈 {G}_{{f}_{2}}^{max} - {G}_{{f}_{2}}^{min} 〉 \} \\ ⋮ \\ \{ {f}_{1} 〈 {G}_{{f}_{1}}^{max} - {G}_{{f}_{1}}^{min} 〉 , {f}_{2} 〈 {G}_{{f}_{2}}^{max} - 1 〉 \} , … , \{ {f}_{1} 〈 {G}_{{f}_{1}}^{max} - {G}_{{f}_{1}}^{min} 〉 , {f}_{2} 〈 {G}_{{f}_{2}}^{max} - {G}_{{f}_{2}}^{min} 〉 \} ,\end{matrix} \qquad ( 27 )$$

where each entry is to be added to the listing of adjustment options Φ̅.

The hub may determine how many and what kind of adjustment options to add to the listing of available adjustment options Φ̅ in various embodiments based on whether the potential flows included in the immediate previous first entry Φ̅[1] were not included in any of the previous first entries Φ̅[1] during the past iterations. In such embodiments, the hub may maintain previous flow information 860, identifying all previous flows included within Φ̅[1], represented as Ω, as well as the set of subsets of previous adjusted flows Ω( [symbol] (Ω)). The set of previous flows Ω contains flows that the hub previously assessed during some prior iteration. In this way, the hub may maintain knowledge of which adjustment options have been checked. Where the first entry Φ̅[1] of the previous iteration contains flows that are already in Ω, the update algorithms discussed above may be applied, as illustrated in the update conducted in iteration 820.

Where the first entry Φ̅[1] of the previous iteration contains a new flow not identified in Ω, a combination of the update algorithms discussed above with respect to FIG. 8 may be applied, in addition to

∀X∈ [symbol] (Ω), add new entry {Φ̅[1], {fᵢ [symbol] G_{f}_{ᵢ}^{max}−1 [symbol] fᵢ∈X}}. (28)

Iteration 830 of FIG. 8 illustrates the combination of (28) with at least one of the above algorithms. As shown in the illustrated example, iteration 830 includes adjustment option 807, which results from (26), and adjustment option 806, which results from (28).

| | |
|---|---|
| Φ̅ | List of adjustment options |
| Ω | Set of previous flows in Φ̅[1] |
| [symbol] (Ω) | Set of subsets of Ω |

```
Algorithm 4 Updating list of adjustment options
Input: Fₑ, fₙ . Φ̅
Output: updated Φ̅
  1: if first time executing algorithm then
  2: Initialize Vector Φ̅: Φ̅[i] = fᵢ [symbol] G_{f}_{ᵢ} [symbol]  where G_{f}_{ᵢ} = G_{f}_{ᵢ}^{max} − 1, ∀ fᵢ ∈ Fₑ ∪ fₙ if G_{f}_{ᵢ}^{max} >
    G_{f}_{ᵢ}^{min} .
  3: Sort Φ̅ based on ascending order of E_{Φ̅[i]}(G_{Φ̅[i]}), i = 1, . . . , ||Φ̅||.
  4: Ω ← Φ̅[1].
  5: return.
  6: end if
  7: if Φ̅[1] contains a new flow that is not in Ω then
  8: ∀X ∈ [symbol]  (Ω) add a new entry to Φ̅ that includes Φ̅[1] and all fᵢ [symbol] G_{f}_{ᵢ}^{max} −1 [symbol] , fᵢ ∈ X.
  9: Ω ← Φ̅[1].
10: end if
11: if Φ̅[1] contains a single flow fᵢ where G_{f}_{ᵢ} > G_{f}_{ᵢ}^{min} then
12: add new entry to Φ̅ that includes fᵢ [symbol] G_{f}_{ᵢ} − 1 [symbol] .
13: end if
14: if Φ̅[1] includes more than one flow where ∀fᵢ ∈ Φ̅[1], G_{f}_{ᵢ} = G_{f}_{ᵢ}^{max} − 1 then
15: add ${\prod }_{{f}_{i} ∈ \overline{Φ} [ 1 ]} ( {G}_{{f}_{i}}^{max} - {G}_{{j}_{i}}^{min} ) - 1$
    new entries to Φ̅. Each new entry includes all fᵢ ∈ Φ̅[1] and
    the new entries together cover all possible combinations of fᵢ [symbol] G_{f}_{ᵢ}^{max} − aᵢ [symbol] , fᵢ ∈ Φ̅[1]
    where 1 ≤ aᵢ ≤ G_{f}_{ᵢ}^{min}, except for the one already represented by Φ̅[1].
16: end if
17: Delete Φ̅[1].
18: Sort Φ̅ based on ascending order of E_{Φ̅[i]} (G_{Φ̅[i]}), i, = 1, . . . , ||Φ̅||.
```

Referring back to FIG. 7B, at 716, the hub determines whether there is a valid adjustment option Φ_{B} available as the first entry Φ̅[1] of the listing of available adjustment options Φ̅. In other words, the hub determines whether Φ̅[1]≠Ø. Where Φ̅[1]≠Ø, the hub may set the adjustment option Φ_{B} to the first entry Φ̅[1] at 718. By setting the adjustment option Φ_{B=(}1) [1] , the hub can assess whether sufficient resources are available at 706.

Where Φ̅[1]=Ø, the connection process 700 may stop iterating through admission control scheme 750 and proceed to identify if there is an identified best termination option Ψ_{U} available at 720 shown on FIG. 7C. As discussed above, the admission control scheme 750 identifies if a termination option Ψ_{B} is available if sufficient resources are not available to admit a requesting flow fₙ based solely on the adjustment option Φ_{B} at 710, and (if necessary) updates the current best adjustment/termination option pair (Φ_{U}, Ψ_{U}) at 712. Where Φ̅[1]=Ø, the current best adjustment/termination option pair (Φ_{U}, Ψ_{U}) becomes the identified best adjustment/termination option pair (Φ_{U}, Ψ_{U}) because no further iterations of the admission control scheme 750 occur.

In various embodiments, the hub may check to see if the identified best termination option Ψ_{U} is a null set at 720. If Ψ_{U}=Ø, that means that there is no termination option Ψ_{B} for any available adjustment option Φ_{B} that would free enough resources to admit the requesting flow fₙ. Accordingly, the hub may reject the requesting flow fₙ at 722. If Ψ_{U}≠Ø, that means that there is a best adjustment/termination option pair (Φ_{U}, Ψ_{U}) that would free up sufficient resources to admit the requesting flow fₙ while still meeting the QoS requirements of all the flows fᵢ∈Fₑ and fₙ. Accordingly, the hub may apply the best adjustment option Φ_{U} and best termination option Ψ_{U} and admit the requesting flow fₙ at 724. This would result in greater bandwidth efficiency than mere termination alone, as the greatest number of flows may be admitted without adversely impacting the QoS requirements of all flows.

As discussed above, the connection process 700 of FIGS. 7A, 7B, and 7C was discussed with respect to the situation where Fᵣ=Ø. Meaning that any new flow that is denied admission, or any existing flow that is terminated, is not automatically reconsidered for admission, but must re-send a connection request in later flames to seek joining the BAN. However, in embodiments utilizing in-band signaling, the connection request of a new, but denied, flow is valid until the end of the current frame's unreserved period, and an existing flow is not made aware of the termination until the next frame in which it has an allocation slot. In such cases, Fᵣ≠Ø, and the denied requesting flow and/or terminated existing flows could potentially be admitted into the BAN when the arrival of another new request leads to the termination of a higher rank flow. Accordingly, initial admission decisions may not necessarily be final. That is, in a single frame, a late arriving request could potentially overturn a prior admission decision made for an earlier request. Such a situation is relevant in BANs because of the heterogeneous traffic types, each with varied QoS requirements.

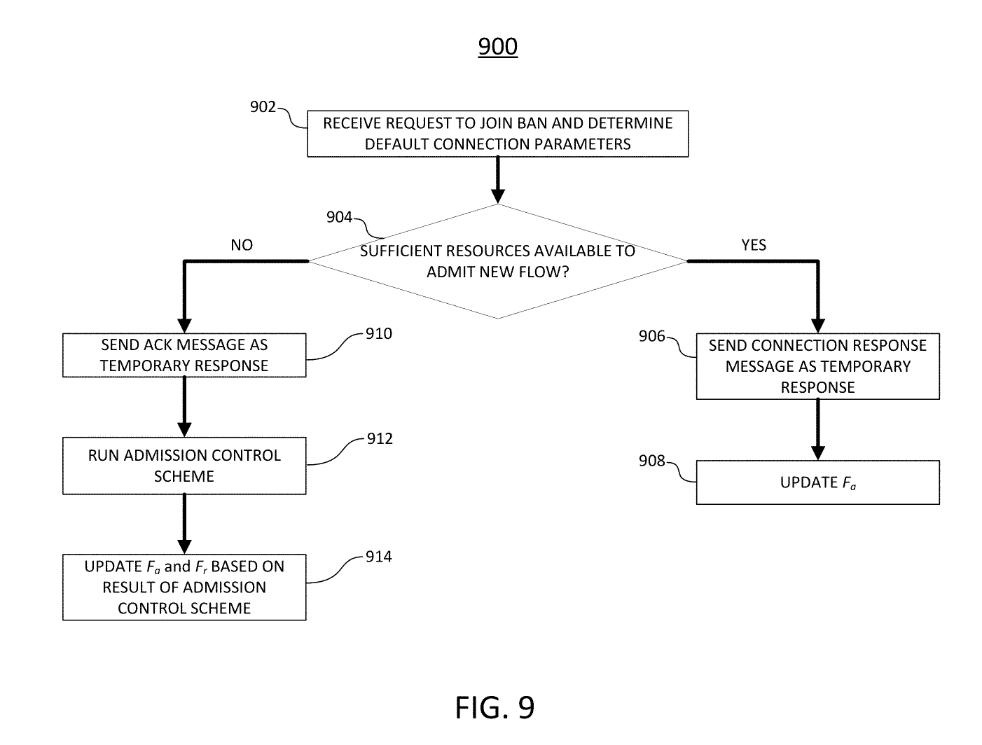

To address this situation, the connection process may include multiple stages to enable the hub to identify the optimal set of flows and connection parameters throughout an entire frame. FIG. 9 illustrates an example connection process 900 in accordance with embodiments of the technology disclosed herein. At 902, the hub receives a request to join the BAN from a new flow and determines allowable connection parameters. In some embodiments, the reception of a request and determination of allowable connection parameters at 902 may be similar to the hub's determinations at 702 and 704 in the example connection process 700 discussed with respect to FIG. 7A.

At 904, the hub may perform an initial determination whether there are sufficient resources to admit the requesting flow. As discussed above, where Fᵣ≠Ø there is a chance that an earlier determination of the optimal set of flows and connection parameters may be changed due to a later arriving request to join the BAN from a subsequent flow. In some cases, running through the iterations of the admission process may be too lengthy to send back a result to the BAN device in timely manner (i.e., within SIFS of receiving the request). Moreover, the results of the admission process may be overridden by a later received join request. Therefore, sending multiple connection response messages, such as the connection response message discussed above with respect to FIG. 2, would result in an increase in the power-consumption of devices within the BAN, reducing the efficiency of the system. Therefore, in some embodiments, the hub may perform the initial determination at 904 to determine a type of temporary response to send to the BAN device. The use of temporary messages enables the hub to acknowledge receipt of a request while conducting the admission process, where appropriate.

If the hub determines that there are sufficient resources to admit the requesting flow, the temporary response comprising a connection response message may be sent at 906. The temporary response may contain the information contained in the connection response message discussed with respect to FIG. 2, including the one or more connection parameters for the requesting flow. At 908, the set of admitted flows Fₐ may be updated. The set of admitted flows Fₐ is updated to reflect the admission of the requesting flow fₙ such that Fₐ←Fₑ∪fₙ. In this way, the hub may maintain which flows are currently provisionally admitted into the BAN for subsequent join requests during the same unreserved period.

If the hub determines that there is insufficient resources to admit the requesting flow, the temporary response comprising an acknowledgement (ACK) message may be sent at 910. In various embodiments, the ACK message may simply indicate that the hub has received the request message. In some embodiments, the ACK message may include one or more additional indicators, for example, including but not limited to: estimated time to respond; time of reception; number of request from other flows; among others.

Following the temporary message comprising the ACK is sent, the hub may run the admission control scheme at 912. The ACK enables the hub to have sufficient time to run the admission control scheme without leaving the requesting BAN device in limbo as to the status of its request message. In some embodiments, the admission control scheme may be similar to the admission control scheme 750 discussed above with respect to FIG. 7B.

Based on the result of the admission control scheme at 912, the requesting flow fₙ may be admitted into the BAN, one or more flows from the set of existing flows Fₑ may be terminated, and/or connection parameters of one or more flows in the set of admitted flows Fₐ, may be adjusted. Therefore, the hub may update the set of admitted flows Fₐ and the set of requesting flows residing in the BAN prior to fₙ's join request Fᵣ at 814 based on the result of the admission control scheme at 812. The update ensures that the hub is aware of the current state of the BAN based on received requests when determining whether to admit each subsequent flow received within the unreserved period of the frame. Therefore, the hub may ensure that the optimal set of flows still meeting the QoS requirements of the heterogeneous flows may be admitted into the BAN in the next frame, increasing bandwidth efficiency.

One or more update procedures may occur at 914, depending on the result of the admission control scheme. In some cases, the admission control scheme may determine that the requesting flow may be admitted merely by adjusting the connection parameters of one or more flows. In such cases, the update procedure at 914 may merely add the requesting flow fₙ to the set of admitted flows Fₐ, similar to the update procedure at 908.

In other cases, the hub may determine that the requesting flow may be admitted through a combination of adjustment and termination. In such embodiments, if the set of terminating flows Ψ_{U} satisfies max_{f}_{ⱼ}_{∈Ψ}_{_{U}}H_{f}_{ⱼ}<min_{f}_{ᵢ}_{∈F}_{ᵣ}H_{f}_{ᵢ}, the hub may update the sets by:

Fᵣ←Fᵣ∪Ψ_{U} and Fₐ←Fₑ∪fₙ−Ψ_{U}, (29)

where max_{f}_{ⱼ}_{∈Ψ}_{_{U}}H_{f}_{ⱼ}<min_{f}_{ᵢ}_{∈F}_{ᵣ}H_{f}_{ᵢ} means that the termination of flows in Ψ_{U} from the BAN as a result of fₙ joining would not help any of the flows in Fᵣ join the BAN (i.e., would not free up sufficient resources to admit any of the flows in Fᵣ to join the BAN while meeting all heterogeneous QoS requirements). This may result because a flow resides in Fᵣ because a higher rank flow inside the BAN is holding back the flow in Fᵣ from joining, meaning that termination of a lower ranked flow would not be of any help.

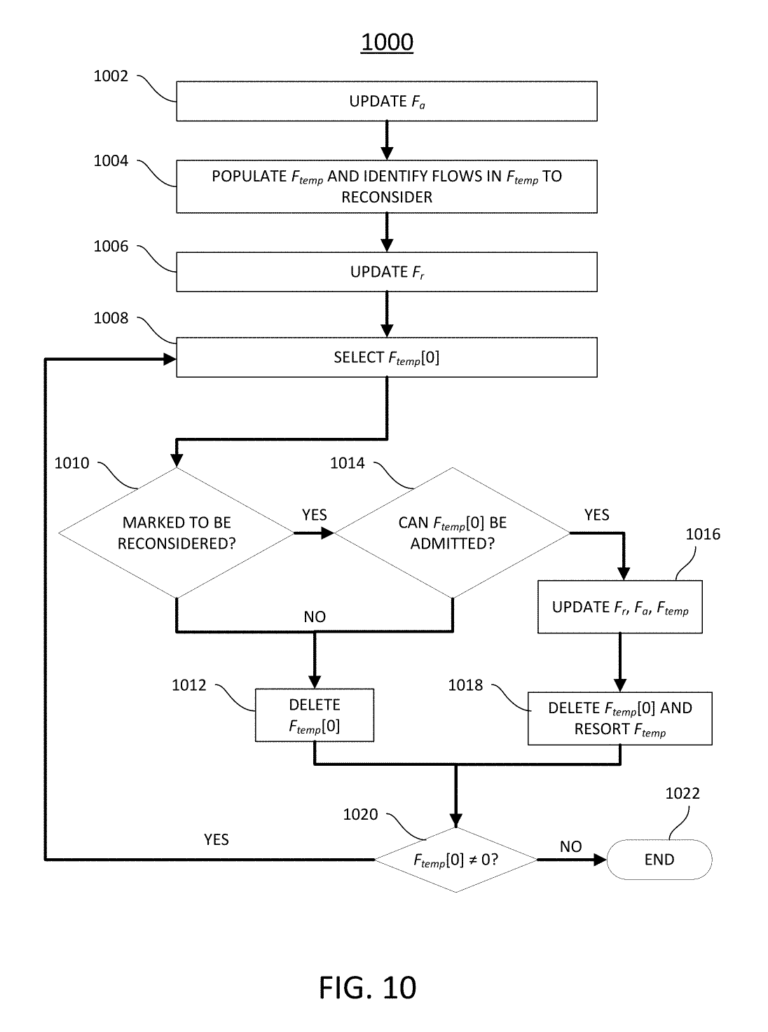

In some situations, simply adding and deleting flows may not be sufficient to address the situation because the termination of flows identified in Ψ_{U} may result in further admissions and terminations. Accordingly, the hub may implement a more involved update procedure at 914 to address this situation. FIG. 10 illustrates an example involved update procedure 1000 in accordance with embodiments of the technology disclosed herein. The example involved update procedure 1000 may be implemented where max_{f}_{ⱼ}_{∈Ψ}_{_{U}}H_{f}_{ⱼ}≥min_{f}_{ᵢ}_{∈F}_{ᵣ}H_{f}_{ᵢ} in some embodiments. At 1002, the hub may update the set of admitted flows Fₐ in a manner similar to the update of the set of admitted flows discussed above with respect to (28).

At 1004, the hub may identify flows to reconsider and populate a listing of flows for reconsideration Fₜₑₘₚ. The listing Fₜₑₘₚ may include all flows in Fᵣ∪Ψ_{U} that have a lower rank than the maximum rank of flows in Ψ_{U} (max_{f}_{ⱼ}_{∈Ψ}_{_{U}}H_{f}_{ᵢ}). In other words, for fᵢ ∈(Fᵣ∪Ψ_{U}) and H_{f}_{ᵢ}<max_{f}_{ⱼ}_{∈Ψ}_{_{U}}H_{f}_{ⱼ}, the hub may add the flow fᵢ to the listing Fₜₑₘₚ. In some embodiments, the hub may traverse all the flows in the listing Fₜₑₘₚ to determine whether the hub can now admit those flows. To increase efficiency, the hub may only consider a subset of the flows in the listing Fₜₑₘₚ in some embodiments. For example, in various embodiments the hub may identify which flows fᵢ to reconsider based on the characteristics of the flows, such as the relative ranks, value of one or more connection parameters, or some other characteristic. In some embodiments, the hub may determine which characteristic to consider, whereas in other embodiments a user may be able to set the characteristics to consider.

In various embodiments, the flows for reconsideration may be identified. For example, in some embodiments the hub may determine which flows to reconsider based on verification of the below if-clause:

(fᵢ∈Fᵣ)?(CHK_{f}_{ᵢ}=1): (CHK_{f}_{ᵢ}=0), (30)

where CHK_{f}_{ᵢ} represents a Boolean variable indicating whether a flow should be checked for readmission, where CHK_{f}_{ᵢ}=1 indicates that the flow should be checked and CHK_{f}_{ᵢ}=0 indicates that reconsideration should not occur. As can be seen in equation (30), in some embodiments the terminated flows in Ψ_{U} may not be considered immediately for readmission into the BAN. In other words, the hub may mark all flows fᵢ within Ψ_{U} as CHK_{f}_{ᵢ}=0. After determining Fₜₑₘₚ, the hub may update Fᵣ at 1006, such that Fᵣ←Fᵣ∪Ψ_{U}. In some embodiments, the hub may sort the listing Fₜₑₘₚ based on decreasing flow ranks, such that the first entry in listing Fₜₑₘₚ represents the flow with the highest ranking. By sorting the listing Fₜₑₘₚ in such a manner, the hub may ensure that it admits the highest ranked flows first, thereby increasing bandwidth efficiency and making sure higher ranked flows are admitted before lower ranked flows. In some embodiments, the sorting of the listing Fₜₑₘₚ may occur at 1004.

At 1008, the hub selects the first entry Fₜₑₘₚ [0] in the listing Fₜₑₘₚ and, at 1010, determines whether the flow is to be reconsidered. For example, where the hub determines whether to reconsider a flow based on (30), the hub may determine whether the CHK_{F}_{ₜₑₘₚ}_{[}0]=1. If the flow is not marked to be reconsidered (e.g., CHK_{F}_{ₜₑₘₚ}_{[}0]=0), the hub may delete the first entry Fₜₑₘₚ[0] at 1012. The hub may determine whether Fₜₑₘₚ[0]≠0 at 1020, indicating that there are still flows within Fₜₑₘₚ that may be reconsidered for admission. If the hub determines Fₜₑₘₚ[0]=0 at 1020, the hub may end the update procedure at 1022. In some embodiments, where there are additional requests to join to be considered, the hub may revert to the beginning of the admission process for any subsequent requests, for example the admission process 700 discussed with respect to FIGS. 7A, 7B, and 7C, or the admission process 900 discussed with respect to FIG. 9.

Where CHK_{F}_{ₜₑₘₚ}_{[}0]=1, the hub may determine whether the first entry Fₜₑₘₚ[0] may be admitted into the BAN at 1014. In some embodiments, the hub may run the admission control scheme 750 discussed with respect to FIGS. 7A, 7B, and 7C. If the hub determines that the flow cannot be admitted, the hub may delete the first entry Fₜₑₘₚ[0] at 1012.

Where the hub determines that the first entry Fₜₑₘₚ[0] may be admitted at 1014, the hub may update the set of admitted flows Fₐ, the set of requesting flows Fᵣ, and the listing Fₜₑₘₚ at 1018. In some embodiments, the hub may update the different listings as follows:

Fₐ←Fₐ∪Fₜₑₘₚ[0]−Ψ_{U}^{temp}, (31)

Fᵣ←Fᵣ−Fₜₑₘₚ[0]∪Ψ_{U}^{temp}, (32)

mark CHK_{f}_{ᵢ}=1 for ∀fᵢ∈Fₜₑₘₚ where H_{f}_{ᵢ}<max_{f}_{ⱼ}_{∈Ψ}_{_{U}}^{temp} H_{f}_{ⱼ}, (33)

append each fᵢ∈Ψ_{U}^{temp} to the end of Fₜₑₘₚ, (34)

mark CHK_{f}_{ᵢ}=0 for ∀fᵢ∈Ψ_{U}^{temp}, (35)

where Ψ_{U}^{temp} represents the set of terminated flows when the first entry Fₜₑₘₚ[0] is admitted. In (31) and (32), the first entry Fₜₑₘₚ[0] is added to Fₐ and removed from Fᵣ. As can be seen in (33), (34), and (35), the hub may update the listing Fₜₑₘₚ for use in subsequent iterations. The hub may mark the flows in Fₜₑₘₚ with rank lower than the flows in Ψ_{U}^{temp} for reconsideration (e.g., CHK_{f}_{ᵢ}=1), and add flows within _{U}^{temp} to the listing Fₜₑₘₚ (and mark those as not to be reconsidered, similar to the terminated flows within Ψ_{U} discussed above with respect to 1004). After updating the set of admitted flows Fₐ, the set of requesting flows Fᵣ, and the listing Fₜₑₘₚ at 1016, the hub may delete Fₜₑₘₚ[0] then resort the listing Fₜₑₘₚ to have the first entry Fₜₑₘₚ[0] correspond with the flow having the highest rank in the listing Fₜₑₘₚ at 1018. The hub may then determine whether Fₜₑₘₚ[0]≠0 at 1020, as discussed above.

As used herein, the term set may refer to any collection of elements, whether finite or infinite. The term subset may refer to any collection of elements, wherein the elements are taken from a parent set; a subset may be the entire parent set. The term proper subset refers to a subset containing fewer elements than the parent set. The term sequence may refer to an ordered set or subset. The terms less than, less than or equal to, greater than, and greater than or equal to, may be used herein to describe the relations between various objects or members of ordered sets or sequences; these terms will be understood to refer to any appropriate ordering relation applicable to the objects being ordered.

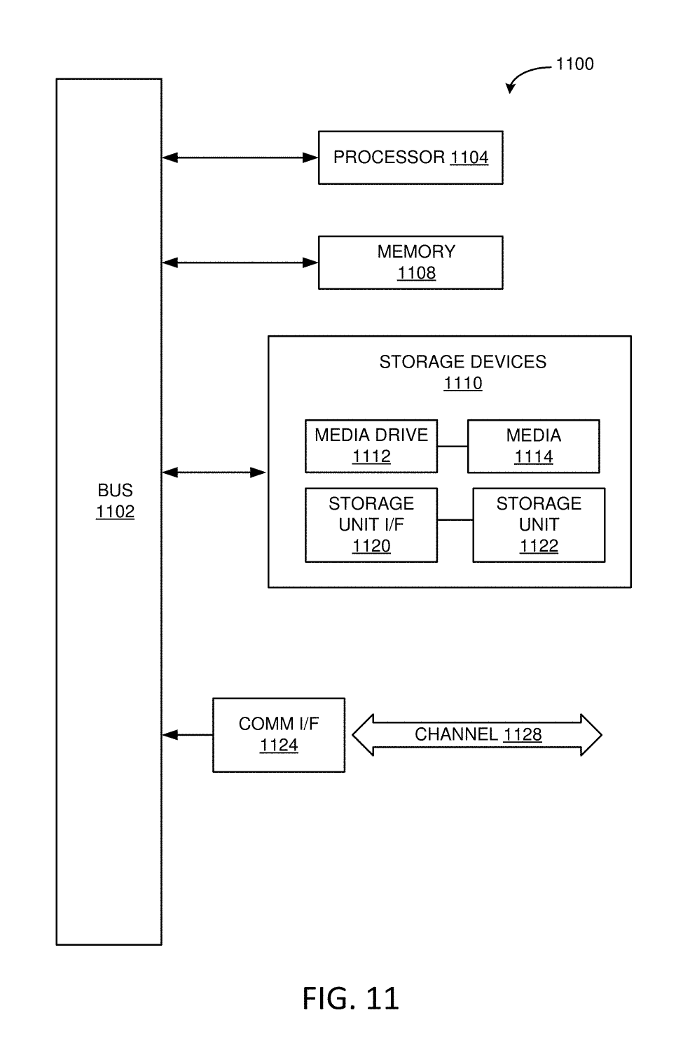

As used herein, the term component might describe a given unit of functionality that can be performed in accordance with one or more embodiments of the technology disclosed herein. As used herein, a component might be implemented utilizing any form of hardware, software, or a combination thereof. For example, one or more processors, controllers, ASICs, PLAs, PALs, CPLDs, FPGAs, logical components, software routines or other mechanisms might be implemented to make up a component. In implementation, the various components described herein might be implemented as discrete components or the functions and features described can be shared in part or in total among one or more components. In other words, as would be apparent to one of ordinary skill in the art after reading this description, the various features and functionality described herein may be implemented in any given application and can be implemented in one or more separate or shared components in various combinations and permutations. Even though various features or elements of functionality may be individually described or claimed as separate components, one of ordinary skill in the art will understand that these features and functionality can be shared among one or more common software and hardware elements, and such description shall not require or imply that separate hardware or software components are used to implement such features or functionality.

Where components or components of the technology are implemented in whole or in part using software, in one embodiment, these software elements can be implemented to operate with a computing or processing component capable of carrying out the functionality described with respect thereto. One such example computing component is shown in FIG. 11. Various embodiments are described in terms of this example-computing component 1100. After reading this description, it will become apparent to a person skilled in the relevant art how to implement the technology using other computing components or architectures.

Referring now to FIG. 11, computing component 1100 may represent, for example, computing or processing capabilities found within desktop, laptop and notebook computers; hand-held computing devices (PDA's, smart phones, cell phones, palmtops, etc.); mainframes, supercomputers, workstations or servers; or any other type of special-purpose or general-purpose computing devices as may be desirable or appropriate for a given application or environment. Computing component 1100 might also represent computing capabilities embedded within or otherwise available to a given device. For example, a computing component might be found in other electronic devices such as, for example, digital cameras, navigation systems, cellular telephones, portable computing devices, modems, routers, WAPs, terminals and other electronic devices that might include some form of processing capability.

Computing component 1100 might include, for example, one or more processors, controllers, control components, or other processing devices, such as a processor 1104. Processor 1104 might be implemented using a general-purpose or special-purpose processing engine such as, for example, a microprocessor, controller, or other control logic. In the illustrated example, processor 1104 is connected to a bus 1102, although any communication medium can be used to facilitate interaction with other components of computing component 1100 or to communicate externally.

Computing component 1100 might also include one or more memory components, simply referred to herein as main memory 1108. For example, preferably random access memory (RAM) or other dynamic memory, might be used for storing information and instructions to be executed by processor 1104. Main memory 1108 might also be used for storing temporary variables or other intermediate information during execution of instructions to be executed by processor 1104. Computing component 1100 might likewise include a read only memory (“ROM”) or other static storage device coupled to bus 1102 for storing static information and instructions for processor 1104.

The computing component 1100 might also include one or more various forms of information storage mechanism 1110, which might include, for example, a media drive 1112 and a storage unit interface 1120. The media drive 1112 might include a drive or other mechanism to support fixed or removable storage media 1114. For example, a hard disk drive, a floppy disk drive, a magnetic tape drive, an optical disk drive, a CD or DVD drive (R or RW), or other removable or fixed media drive might be provided. Accordingly, storage media 1114 might include, for example, a hard disk, a floppy disk, magnetic tape, cartridge, optical disk, a CD or DVD, or other fixed or removable medium that is read by, written to or accessed by media drive 1112. As these examples illustrate, the storage media 1114 can include a computer usable storage medium having stored therein computer software or data.

In alternative embodiments, information storage mechanism 1110 might include other similar instrumentalities for allowing computer programs or other instructions or data to be loaded into computing component 1100. Such instrumentalities might include, for example, a fixed or removable storage unit 1122 and an interface 1120. Examples of such storage units 1122 and interfaces 1120 can include a program cartridge and cartridge interface, a removable memory (for example, a flash memory or other removable memory component) and memory slot, a PCMCIA slot and card, and other fixed or removable storage units 1122 and interfaces 1120 that allow software and data to be transferred from the storage unit 1122 to computing component 1100.

Computing component 1100 might also include a communications interface 1124. Communications interface 1124 might be used to allow software and data to be transferred between computing component 1100 and external devices. Examples of communications interface 1124 might include a modem or softmodem, a network interface (such as an Ethernet, network interface card, WiMedia, IEEE 802.XX or other interface), a communications port (such as for example, a USB port, IR port, RS232 port Bluetooth® interface, or other port), or other communications interface. Software and data transferred via communications interface 1124 might typically be carried on signals, which can be electronic, electromagnetic (which includes optical) or other signals capable of being exchanged by a given communications interface 1124. These signals might be provided to communications interface 1124 via a channel 1128. This channel 1128 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to media such as, for example, memory 1108, storage unit 1120, media 1114, and channel 1128. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing component 1100 to perform features or functions of the disclosed technology as discussed herein.

While various embodiments of the disclosed technology have been described above, it should be understood that they have been presented by way of example only, and not of limitation. Likewise, the various diagrams may depict an example architectural or other configuration for the disclosed technology, which is done to aid in understanding the features and functionality that can be included in the disclosed technology. The disclosed technology is not restricted to the illustrated example architectures or configurations, but the desired features can be implemented using a variety of alternative architectures and configurations. Indeed, it will be apparent to one of skill in the art how alternative functional, logical or physical partitioning and configurations can be implemented to implement the desired features of the technology disclosed herein. Also, a multitude of different constituent component names other than those depicted herein can be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the disclosed technology is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the disclosed technology, whether or not such embodiments are described and whether or not such features are presented as being a part of a described embodiment. Thus, the breadth and scope of the technology disclosed herein should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “component” does not imply that the components or functionality described or claimed as part of the component are all configured in a common package. Indeed, any or all of the various components of a component, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A method, comprising:
a hub device receiving a join request message during an unreserved period of a frame period from a requesting data flow associated with a connecting network device to join a network;
the hub device determining an available range for one or more connection parameters for the requesting data flow;
the hub setting the one or more connection parameters for the requesting data flow to a set of default connection parameters;
the hub determining whether sufficient resources are available within the network to admit the requesting data flow based on the default connection parameters for the requesting data flow; and
the hub admitting the requesting data flow if the hub determines sufficient resources are available, or the hub conducting an admission control scheme designed to identify an adjustment option, a termination option, or combination thereof that would result in sufficient resources being available within the network to admit the requesting flow.

2. The method of claim 1, the hub determining an available range for one or more connection parameters for the requesting data flow comprising the hub obtaining one or more QoS requirements associated with the requesting data flow, and a power constraint and a buffer size constraint associated with the connecting BAN device.

3. The method of claim 2, wherein the one or more QoS requirements, a power constraint, and a buffer size constraint are included within the join request message received by the hub for the requesting data flow.

4. The method of claim 2, wherein the one or more QoS requirements are included within the join request message, and the power constraint and the buffer size constraint associated with the connecting BAN device are identified by the hub during an association process.

5. The method of claim 2, wherein the QoS requirements for the requesting data flow may include one or more of: a traffic generation rate of the requesting data flow; a tolerable delay of the requesting data flow; a priority of the requesting data flow; a reliability requirement of the requesting data flow; or a sensing duration of a requesting data flow.

6. The method of claim 1, wherein the hub determining whether sufficient resources are available comprises determining whether condition
$${x}_{{f}_{n}} \leq ( 1 - β ) L - ɛ - X ⌊ {tT}_{{f}_{n}} ⌋ ∀ t ∈ \{ \begin{matrix}0 \text{:} min & ( ⌊ \frac{{CD}_{{f}_{n}}}{{T}_{{f}_{n}}} ⌋ ,\end{matrix} ⌊ \frac{{γ}_{N}}{{T}_{{f}_{n}}} ⌋ ) \}$$
is satisfied.

7. The method of claim 6, further comprising the hub checking to determine the number of frames during which an overall pattern of the allocation slots assigned to each flow is periodic, and if the mentioned number of frames is larger than a given threshold, minimizing a computational impact of determining whether the condition is satisfied.

8. The method of claim 7, wherein if the periodicity condition exists, the hub checking whether x_{f}_{ₙ}≤(1−β)L−ϵ−\tilde{X}[tT_{f}_{ₙ}mod \hat{T}ₘ] for
$$t ∈ \{ \begin{matrix}0 \text{:} min & ( ⌊ \frac{{CD}_{{f}_{n}} - {a}^{*} {T}_{{f}_{n}}}{{T}_{{f}_{n}}} ⌋ ,\end{matrix} \frac{LCM ( {\hat{T}}_{m} , {T}_{{f}_{n}} )}{{T}_{{f}_{n}}} - 1 ) \} .$$

9. The method of claim 6, wherein the hub determining whether the condition is satisfied, comprises determining whether the condition is satisfied for the smaller of a duration of the requesting flow's connection
$$( ⌊ \frac{{CD}_{{f}_{n}}}{{T}_{{f}_{n}}} ⌋ ) ;$$
or a remaining duration of a last flow to end among existing flows
$$( ⌊ \frac{{γ}_{N}}{{T}_{{f}_{n}}} ⌋ ) .$$

10. The method of claim 1, the network comprising a set of existing data flows, each data flow of the set of existing data flows associated with a connected network device and comprising one or a plurality of heterogeneous data flow types, each data flow type having a unique set of QoS requirements, and the hub maintaining a listing of an available range for one or more connection parameters for each data flow of the set of existing data flows.

11. The method of claim 10, wherein an adjustment option comprises the one or more potential flows for at least one data flow of the set of existing data flows, the requesting data flow, or a combination thereof, and the admission control scheme comprises:
the hub device determining a termination option comprising one or more existing data flows;
the hub device determining whether to update a current best adjustment/termination option pair based on the adjustment option and the termination option;
the hub device updating a listing of available adjustment options;
the hub device setting the adjustment option as a first entry in the listing of available adjustment option as the adjustment option; and
the hub reassessing whether sufficient resources are available within the network to admit the requesting data flow based on the adjustment option.

12. The method of claim 11, further comprising the hub determining a rank for the requesting data flow and each of the data flows of the set of existing data flows, and the hub determining a termination option comprising:
the hub identifying a set of candidate flows from the set of existing flows;
the hub determining a listing of potential termination options based on the set of candidate flows, each potential termination option comprising one or more candidate flows;
the hub sorting the listing of potential termination options in ascending order based on a defined rank metric associated with each potential termination option; and
the hub selecting a first entry of the listing of potential termination options, wherein the first entry of the listing of potential termination options contains one or more existing data flows, each of the one or more existing data flows having a rank lower than the rank of the requesting data flow.

13. The method of claim 12, wherein the rank for the requesting data flow and each data flow of the set of existing data flows is determined by:
if a priority requirement of a first data flow is greater than a priority requirement of a second data flow, assigning a higher rank to the first data flow and a lower rank to the second data flow, or
where the priority requirement of the first data flow is the same as the priority requirement of a second data flow, if a tolerable delay of the first data flow is less than a tolerable delay of the second data flow, assigning a higher data flow to the first data flow and a lower rank to the second data flow, or
where the priority requirement and tolerable delay of the first data flow is the same as the priority requirement and the tolerable delay of a second data flow, if an allocation slot size for the first data flow is greater than an allocation slot size for the second data flow, assigning a higher rank to the first data flow and a lower rank to the second data flow.

14. The method of claim of claim 11, wherein the hub determines to update the current best adjustment/termination option pair where applying the adjustment option and the termination option prevents termination of a data flow of the existing data flows having a higher rank than the request data flow.

15. The method of claim 11, where the adjustment option is a null set, the hub device updating a listing of available adjustment options, comprises:
the hub calculating an initial potential flow for the requesting data flow and for each data flow of the set of existing data flows in accordance with the formula:
Φ̅:Φ̅[i]=fᵢ [symbol] G_{f}_{ᵢ} [symbol] where G_{f}_{ᵢ}=G_{f}_{ᵢ}^{max}−1, ∀fᵢ∈Fₑ∪fₙ if G_{f}_{ᵢ}^{max}>G_{f}_{ᵢ}^{min},
where Φ̅ is the listing of available adjustment options;
the hub sorting the listing of available adjustment options in ascending order based on energy-consumption of each initial available adjustment option; and
the hub setting the adjustment option as a first entry in the sorted listing of available adjustment options.

16. The method of claim 11, the hub device updating a listing of available adjustment options, where the adjustment option is not a null set, comprises:
the hub identifying one or more potential flows included in a previous adjustment option; and
the hub calculating one or more additional potential flows to add to the listing of available adjustment options.

17. The method of claim 16, wherein the one or more additional potential flows are fᵢ [symbol] G_{f}_{ᵢ}−1 [symbol] as long as an allocation slot gap, G_{f}_{ᵢ}, is greater than a minimum allocation slot gap and less than a maximum allocation slot gap, where the hub determines that the previous adjustment option contains a single data flow.

18. The method of claim 16, where the hub determines that the previous adjustment option contains two or more potential flows, wherein the quantity of additional flows is given by Π_{f}_{ᵢ}_{∈Φ̅[}1](G_{f}_{ᵢ}^{max}−G_{f}_{ᵢ}^{min})−1, for all potential flows included in the previous adjustment option, and as long as an allocation slot gap, G_{f}_{ᵢ}, for each potential flow in the previous adjustment option equals a maximum allocation slot gap minus a single frame.

19. The method of claim 16, where the previous adjustment option contains a potential flow not included in any of the one or more previous adjustment options, the hub adding a new potential flow to the listing of available adjustment options comprising the potential flow not included in any of the one or more previous adjustment options and (fᵢ [symbol] G_{f}_{ᵢ}^{max}−1 [symbol] , fᵢ∈X) for all possible subsets (X) identified in the one or more previous adjustment options.

20. The method of claim 16, further comprising, if the listing of available adjustment options is a null set, the hub applying the termination option and a corresponding adjustment option determined during the admission control scheme, if the termination option does not equal a null set.

21. The method of claim 1, further comprising the hub sending a connection response message to the connecting BAN device associated with the requesting data flow via in-band signaling.

22. The method of claim 1, wherein a result of the admission control scheme applied to the requesting data flow may be changed within a duration of an unreserved period of a current frame.

23. The method of claim 1, further comprising the hub sending a temporary response message to the connecting BAN device associated with the requesting data flow containing the plurality of connection parameters where the hub determines sufficient resources are available within the network based on the default connection parameters.

24. The method of claim 1, further comprising the hub sending a temporary response message to the connecting BAN device associated with the requesting data flow containing an acknowledgement message where the hub determines that insufficient resources are available to admit the requesting data flow based on the default connection parameters.

25. A communication network, comprising:
a frame period including a reserved period and an unreserved period, the reserved period including an allocation slot;
a connected network device associated with the communication network, wherein the connected network device is allocated the allocation slot;
a connecting network device seeking association with the communication network and comprising a requesting data flow; and
a hub within the network, the hub comprising a processor configured to execute the steps of:
receiving a connection request from the connecting network device, the connection request comprising QoS requirements associated with the requesting data flow;
determining whether to reallocate the allocation slot to the connecting network device based on the QoS requirements associated with the requesting data flow; and
transmitting connection parameters to the connecting device if the hub determines that it can reallocate the allocation slot to the connecting network device.

26. The system of claim 25, wherein determining whether to allocate the allocation slot to the connecting network device comprises:
determining an available range of connection parameters for the requesting data flow based on the QoS requirements associated with the requesting data flow;
provisionally allocating a set of default connection parameters to the requesting data flow;
identifying the connecting network device and one or more connected network devices that have a minimum energy consumption within the network when the requesting data flow of the connecting device is admitted into the network to transmit data;
updating a set of assigned connection parameters of the requesting data flow of the connecting network device and a set of assigned connection parameters of the one or more connected network devices based on the identification; and
transmitting the updated set of assigned connection parameters of the requesting data flow to the connecting network device and the set of assigned connection parameters of the one or more connected network devices to the one or more connected network devices, respectively;
wherein the allocation slot is a slot for uplink communication and downlink communication between the hub and the one or more connected network devices, the allocation slot including one or more minislots, the set of assigned connection parameters including a minislot number for the allocation slot, an allocation slot gap for the allocation slot, and the energy consumption associated with uplink communication by the connecting network device and the one or more connected network devices.

27. The system of claim 26, wherein the QoS requirements for the requesting data flow may include one or more of: a traffic generation rate of the requesting data flow; a tolerable delay of the requesting data flow; a priority of the requesting data flow; a reliability requirement of the requesting data flow; or a sensing duration of the requesting data flow.

28. The system of claim 26, determining an available range of connection parameters for the requesting data flow further based on a power constraint and a buffer constraint associated with the connecting network device.

29. The system of claim 26, the processor of the hub further configured to determine an available range of connection parameters for each of the one or more connected network devices and store the determined available ranges of connection parameters for each of the one or more connected network devices in a memory.

30. The system of claim 29, the processor of the hub further configured to:
if sufficient resources are not available within the network to admit the requesting data flow based on the default connection parameters, identifying an adjustment option, the adjustment option comprising one or more potential flows based on the available ranges of connection parameters determined for the requesting data flow and each of the one or more connected network devices; and
identifying the connecting network device and one or more connected network devices that have a minimum energy consumption within the network when the requesting data flow of the connecting device is admitted into the network to transmit data according to the adjustment option.

31. The system of claim 30, the processor of the hub further configured to repeat the identification of an adjustment option as long as the hub identifies an available adjustment option exists within a listing of available adjustment options.

32. The system of claim 30, the processor of the hub further configured to:
if no available adjustment options exist, determining if an available termination option exists, the available termination option comprising one or more connected network devices that, when terminated from the network, would allow admission of the requesting data flow; and
transmitting a connection update message to the one or more connected devices in the available termination option, the connection update message terminating a previous assignment of the allocation slot to the one or more connected devices in the available termination option.

33. The system of claim 32, wherein the one or more connected network devices included in the available termination option each have a priority rank lower than a priority rank of the requesting data flow.
